(19) United States
(12) Patent Application Publication
(10) Pub. No.: US 2018/0285787 A1
(43) Pub. Date: Oct. 4, 2018

(54) OPTIMIZATION SYSTEM, OPTIMIZATION METHOD, AND OPTIMIZATION PROGRAM

(71) Applicant: NEC CORPORATION, Tokyo (JP)

(72) Inventors: Shinji ITO, Tokyo (JP); Ryohei FUJIMAKI, Tokyo (JP)

(73) Assignee: NEC Corporation, Tokyo (JP)

(21) Appl. No.: 15/764,681

(22) PCT Filed: Aug. 9, 2016
(86) PCT No.: PCT/JP2016/003687

§ 371 Date: Mar. 29, 2018

Related U.S. Application Data
(60) Provisional application No. 62/235,044, filed on Sep. 30, 2015.

(51) Int. Cl. G06Q 10/04; G06F 17/18; G06F 15/18; G06F 17/11

(52) U.S. Cl. CPC G06Q 10/04; G06F 17/11; G06F 15/18; G06F 17/18

(57) ABSTRACT

A model input unit 84 receives a linear regression model represented by a function having an objective variable as an explanatory variable. A candidate point input unit 85 receives, for the objective variable included in the linear regression model, at least one candidate point which is a discrete candidate for a possible value of the objective variable. An optimization unit 86 calculates the objective variable that optimizes an objective function having the linear regression model as an argument.

### TECHNICAL FIELD

The present invention relates to an optimization system, an optimization method, and an optimization program that perform optimization based on a predictive model.

### BACKGROUND ART

Various methods for generating predictive models based on past historical data have been proposed in recent years. For example, Patent Literature (PTL) 1 describes a learning method that automatically separates and analyzes mixture data.

As a method for performing optimization on a quantitative problem (hereafter, “mathematical optimization”), numerical optimization (mathematical programming) is known. Examples of mathematical programming include continuous variable-related methods such as linear programming, quadratic programming, and semidefinite programming, and discrete variable-related methods such as mixed integer programming. PTL 2 describes a method for determining an optimal charging schedule by applying mathematical programming to collected data.

### CITATION LIST

### Patent Literature

PTL 1: U.S. Pat. No. 8,909,582

PTL 2: Japanese Patent Application Laid-Open No. 2012-213316

### SUMMARY OF INVENTION

### Technical Problem

Mathematical optimization is typically performed on the premise that data input to mathematical programming is observed. For example, in the case of optimizing production lines of industrial products, data such as the quantity of material, cost, and production time necessary to produce a product in each line is input.

In the case where data is unobserved, however, data needs to be prepared manually,which hinders extensive optimization or frequent optimization. For example, if a future demand predictive line of each product in a retail store is obtained, it is possible to optimize order and stock based on the demand. However, the number of products for which a demand predictive line can be drawn manually is limited. Besides, it is not practical to repeat manual demand prediction upon each order that takes place once in several hours.

For example, to optimize the price of each product for a future period so as to maximize the sales in the period, a complex correlation between the price and demand of a large volume of products needs to be recognized, but manually doing so is difficult,

In view of these findings, the inventors of the present invention made an invention relating to, for example, a method of learning a model for predicting unobservable data from past data by the method described in PTL 2 as an example, automatically generating an objective function of mathematical programming and a constraint condition based on a future prediction result obtained based on the predictive model, and performing optimization. According to such invention, appropriate optimization can be performed even in a situation where there is massive unobservable input data in mathematical optimization or there are complex correlations between massive data.

In a process of performing such optimization, there are instances where the predictive model based on machine learning is based on a non-linear basis function. For example, consider the case of performing, for the above-mentioned price prediction problem, non-linear transformation such as squaring of price and logarithmic transformation of price as a feature value input to the predictive model based on machine learning. In this case, the objective function (sales for a future period) of mathematical optimization is a function of the feature value obtained by complex non-linear transformation of the price, so that efficiently solving such mathematical optimization using a typical method is difficult. Accordingly, it is preferable if mathematical optimization can be solved at high speed with high accuracy even in the case where a predictive model used for optimization is based on a non-linear basis function.

The present invention therefore has an object of providing an optimization system, an optimization method, and an optimization program that can solve mathematical optimization at high speed with high accuracy even in the case where a predictive model used for optimization is based on a non-linear basis function.

### Solution to Problem

An optimization system according to the present invention is an optimization system for optimizing a value of an objective variable so that a value of an objective function is optimal, the optimization system including: a model input unit for receiving a linear regression model represented by a function having the objective variable as an explanatory variable; a candidate point input unit for receiving, for the objective variable included in the linear regression model, at least one candidate point which is a discrete candidate for a possible value of the objective variable; and an optimization unit for calculating the objective variable that optimizes the objective function having the linear regression model as an argument, wherein the optimization unit selects a candidate point that optimizes the objective variable, to calculate the objective variable.

An optimization method according to the present invention is an optimization method form optimizing a value of an objective variable so that a value of an objective function is optimal, the optimization method including: receiving a linear regression model represented by a function having the objective variable as an explanatory variable; receiving, for the objective variable included in the linear regression model, at least one candidate point which is a discrete candidate for a possible value of the objective variable; and calculating the objective variable that optimizes the objective function having the linear regression model as an argument, wherein in the optimization, a candidate point that optimizes the objective variable is selected to calculate the objective variable.

An optimization program according to the present invention is an optimization program applied to a computer for optimizing a value of an objective variable so that a value of an objective function is optimal, the optimization program causing the computer to execute: a model input process of receiving a linear regression model represented by a function having the objective variable as an explanatory variable; a candidate point input process of receiving, for the objective variable included in the linear regression model, at least one candidate point which is a discrete candidate for a possible value of the objective variable; and an optimization process of calculating the objective variable that optimizes the objective function having the linear regression model as an argument, wherein in the optimization process, the computer is caused to select a candidate point that optimizes the objective variable, to calculate the objective variable.

### Advantageous Effects of Invention

According to the present invention, a technically advantageous effect of solving mathematical optimization at high speed with high accuracy even in the case where a predictive model used fix optimization is based on a non-linear basis function can be achieved by the technical means described above.

### BRIEF DESCRIPTION OF DRAWINGS

FIG. 1 is a block diagram depicting an example f the structure of Exemplary Embodiment 1 of an optimization system according to the present invention.

FIG. 2 is a flowchart depicting an example of operation by the optimization system in Exemplary Embodiment 1.

FIG. 3 is an explanatory diagram depicting a modification of the optimization system in Exemplary Embodiment 1.

FIG. 4 is a block diagram depicting an example of the structure of Exemplary Embodiment 2 of an optimization system according to the present invention,

FIG. 5 is an explanatory diagram depicting an example of a screen for receiving input of candidate points.

FIG. 6 is a flowchart depicting an example of operation by the optimization system in Exemplary Embodiment 2.

FIG. 7 is a flowchart depicting an example of operation of solving BQP by SDP relaxation.

FIG. 8 is a flowchart depicting another example of operation of solving BQP by SDP relaxation.

FIG. 9 is a flowchart depicting yet another example of operation of solving BQP by SDP relaxation.

FIG. 10 is a block diagram schematically depicting an optimization system according to the present invention.

FIG. 11 is a schematic block diagram depicting the structure of a computer according to at least one exemplary embodiment.

### DESCRIPTION OF EMBODIMENT

An overview of the present invention is given first. According to the present invention, in a situation where there is massive unobservable input data in mathematical optimization or there are complex correlations between massive data, massive unobservable data or complex data correlations are learned by a machine learning technique to perform appropriate optimization. In detail, according to the present invention, a model for predicting unobservable data from past data is learned by, for example, the method described in PTL 2, and an objective function and a constraint condition in mathematical programming are automatically generated based on a future prediction result obtained based on the predictive model, to perform optimization.

Exemplary embodiments of the present invention are described below, with reference to drawings. The following describes an example where, based on sales prediction of a plurality of products, the prices of the plurality of products are optimized so as to maximize the total sales revenue of the plurality of products, according to need. However, the optimization target is not limited to such an example. In the following description, a variable subjected to prediction by machine learning is referred to as “explained variable”, a variable used for prediction is referred to as “explanatory variable”, and a variable as optimization output is referred to as “objective variable”. These variables are not in an exclusive relationship. For example, a part of explanatory variables can be an objective variable,

### Exemplary Embodiment 1

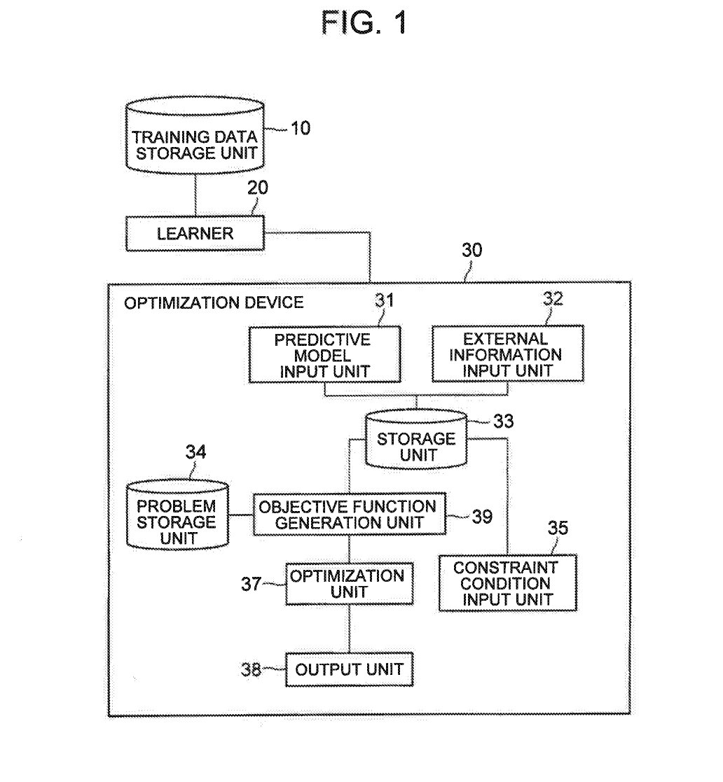

A method of automatically generating an objective function and a constraint condition in mathematical programming based on a future prediction result obtained based on a predictive model and performing optimization is described first. FIG. 1 is a block diagram depicting an example of the structure of Exemplary Embodiment 1 of an optimization system according to the present invention. The optimization system in this exemplary embodiment includes a training data storage unit 10, a learner 20, and an optimization device 30. The optimization system depicted in FIG. 1 corresponds to the information processing system according to the present invention.

The training data storage unit 10 stores each type of training data used by the learner 20 to learn a predictive model. In this exemplary embodiment, the training data storage unit 10 stores historical data acquired in the past, fbr a variable (objective variable) output as an optimization result by the below-mentioned optimization device 30. For example, in the case where the optimization device 30 is to optimize the prices of a plurality of products, the training data storage unit 10 stores the price of each product corresponding to an explanatory variable and the sales amount of each product corresponding to an explained variable, as historical data acquired in the past.

The training data storage unit 10 may also store external information such as weather and calendar information, other than the explained variable historical data and explanatory variable historical data acquired in the past.

The learner 20 learns a predictive model for each set explained variable by machine learning, based on each type of training data stored in the training data storage unit 10. The predictive model learned in this exemplary embodiment is expressed as a function of a variable (objective variable) output as an optimization result by the below-mentioned optimization device 30. In other words, the objective variable (or its function) is the explanatory variable of the predictive model.

For example, in the case of optimizing the prices so as to maximize the total sales revenue, the learner 20 generates, for each target product, a predictive model of sales amount having the price of the product as an explanatory variable, based on past sales information (price, sales amount, etc.) and external information (weather, temperature, etc.). By generating such a predictive model using the sales amounts of the plurality of products as an explained variable, it is possible to model price-demand relationships and market cannibalization caused by competing products, while taking complex external relationships such as weather into account.

The predictive model aeneration method may be any method. For example, a simple regression approach may be used, or the learning method described in PTL 1 may be used.

Here, an optimization target index set is denoted as {m|m=1, . . . , M}. In the above-mentioned example, the optimization target is the price of each product, and M corresponds to the number of products. An object of prediction for each optimization target m is denoted as Sₘ. In the above-mentioned example, Sₘ corresponds to the sales amount of product m. An object of optimization (i.e. objective variable of optimization) for each optimization target m is denoted as Pₘ or P′ₘ. In the above-mentioned example, Pₘ corresponds to the price of product m. When modeling the dependency between Sₘ (e.g. sales amount (demand)) and Pₘ (e.g. price) using linear regression, a predictive model for predicting Sₘ is represented by the following Formula 1 as an example.

$$\begin{matrix}[ Math . 1 ] & \\ {S}_{m} = {a}_{m} + {\sum }_{{m}^{′} = 1}^{M} {\sum }_{d = 1}^{D} {β}_{m {m}^{′}}^{d} {f}_{d} ( {P}_{m}^{′} ) + {\sum }_{d = 1}^{{D}^{′}} {γ}_{d}^{m} {g}_{d} & ( Formula 1 ) \end{matrix}$$

In Formula 1, f_{d} is a feature generation function, and represents transformation for P′ₘ. D is the number of feature generation functions, and indicates the number of transformations performed on P′ₘ. f_{d} may be any function, such as a linear transformation function, or a non-linear transformation function, e.g. logarithm or polynomial. In the case where Pₘ denotes the price of product m and Sₘ denotes the sales amount of product m as mentioned above, f_{d} represents, for example, the sales reaction to the price. The sales reaction is, for example, as follows: a certain price reduction leads to better or worse sales reaction; and the sales amount is squared according to price reduction.

In Formula 1, g_{d} is an external feature (weather, etc. in the above-mentioned example), and D′ is the number of external features. Regarding the external feature, transformation may be performed beforehand. Moreover, α, β, and γ in Formula 1 are constant terms and coefficients of a regression equation obtained as a result of machine learning by the learner 20. As is clear from the above description, the predictive model is learned based on the explained variable (Sₘ) and the explanatory variable (Pₘ, each type of external feature, etc.), indicates the relationship between the explained variable and the explanatory variable, and is represented by a function of the explanatory variable.

The foregoing Formula 1 may be modified as shown in the following Formula 2, based on the passage of time.

$$\begin{matrix}[ Math . 2 ] & \\ {S}_{m}^{( t )} = {a}_{m}^{( t )} + {\sum }_{{m}^{′} = 1}^{M} {\sum }_{d = 1}^{D} {β}_{m {m}^{′}}^{d ( t )} {f}_{d} ( {P}_{m}^{′} ) + {\sum }_{d = 1}^{{D}^{′}} {γ}_{d}^{m ( t )} {g}_{d}^{( t )} & ( Formula 2 ) \end{matrix}$$

In Formula 2, superscript t represents a time index. For example, this corresponds to the case of temporally sliding the training data set by a window function and updating the predictive formula with time t. Thus, the predictive model is learned based on historical data of the objective variable of optimization acquired in the past, and represented by a function having this objective variable as an explanatory variable. Since the learner 20 uses historical data acquired in the past in this way, there is no need to manually generate training data. Moreover, since the predictive model is learned by machine learning, even massive data can be handled, and the model can be automatically relearned to follow the sales amount trend which varies with time. The learner 20 outputs the generated predictive model to the optimization device 30.

The optimization device 30 performs objective optimization. In detail, the optimization device 30 optimizes the value of an objective variable so that the value of an objective function is optimal (maximum, minimum, etc.), while satisfying each type of constraint condition (described in detail later) set for the objective variable and the like. In the above-mentioned example, the optimization device 30 optimizes the prices of the plurality of products.

The optimization device 30 includes a predictive model input unit 31, an external information input unit 32, a storage unit 33, a problem storage unit 34, a constraint condition input unit 35, an optimization unit 37, an output unit 38, and an objective function generation unit 39.

The predictive model input unit 31 is a device that receives a predictive model. In detail, the predictive model input unit 31 receives the predictive model learned by the learner 20. When receiving the predictive model, the predictive model input unit 31 also receives parameters necessary for the optimization process. The predictive model input unit 31 may receive a predictive model obtained by an operator manually correcting the predictive model learned by the learner 20. The predictive model input unit 31 thus receives a predictive model used in the optimization device 30, and so can be regarded as the predictive model reception unit for receiving a predictive model.

The external information input unit 32 receives external information used for optimization other than the predictive model. As an example, in the case of optimizing the prices for next week in the above-mentioned example, the external information input unit 32 may receive information about next week's weather. As another example, in the case where next week's store traffic is predictable, the external information input unit 32 may receive information about next week's store traffic. As in this example, the external information may be generated by the predictive model resulting from machine learning. The external information received here is, for example, applied to the explanatory variable of the predictive model.

The storage unit 33 stores the predictive model received by the predictive model input unit 31. The storage unit 33 also stores the external information received by the external information input unit 32. The storage unit 33 is realized by a magnetic disk device as an example.

The problem storage unit 34 stores an evaluation scale of optimization by the optimization unit 37. In detail, the problem storage unit 34 stores a mathematical programming problem to be solved by optimization. The mathematical programming problem is stored in the problem storage unit 34 beforehand by a user or the like. The, problem storage unit 34 is realized by a magnetic disk device as an example.

In this exemplary embodiment, the objective function or constraint condition of the mathematical programming problem is defined so that the predictive model is a parameter. In other words, the objective function or constraint condition in this exemplary embodiment is defined as a functional of the predictive model. In the above-mentioned example, the problem storage unit 34 stores a mathematical programming problem for maximizing the total sales revenue. In this case, the optimization unit 37 optimizes the price of each product so as to maximize the total sales revenue. Since the sales revenue of each product can be defined by multiplication of the price of the product by the sales amount predicted by the predictive model, the problem storage unit 34 may store, for example, a mathematical programming problem specified by the following Formula 3.

$$\begin{matrix}[ Math . 3 ] & \\ {max}_{Z} {\sum }_{t ∈ {T}_{te}} {\sum }_{m = 1}^{M} {P}_{m} {S}_{m}^{( t )} & ( Formula 3 ) \end{matrix}$$

In Formula 3, Tₜₑ is a time index of a period subjected to optimization. For example, in the case of maximizing the total sales revenue for next week where the unit of time is “day”, Tₜₑ is a set of dates for one week from the next day.

The constraint condition input unit 35 receives a constraint condition in optimization. The constraint condition may be any condition. An example of the constraint condition is a business constraint. For example, in the case where a quota is imposed for the sales amount of a product, a constraint condition “Sm(t)≥quota” may be used. Moreover, a constraint condition (e.g. P₁≥P₂) specifying the magnitude relationship between the prices P₁ and P² of respective two products may be used.

In the case where the constraint condition has the predictive model as an argument, the constraint condition input unit 35 may operate as the predictive model reception unit for receiving a predictive model, or read the predictive model stored in the storage unit 33. The constraint condition input unit 35 may then generate the constraint condition having the acquired predictive model as an argument.

The objective function generation unit 39 generates the objective function of the mathematical programming problem. In detail, the objective function generation unit 39 generates the objective function of the mathematical programming problem having the predictive model as a parameter. For example, the objective function generation unit 39 reads, from the storage unit 33, the predictive model to be applied to the mathematical programming problem stored in the problem storage unit 34, and generates the objective function.

A plurality of predictive models are learned by machine learning depending on the object of prediction, as in the above-mentioned example. In this case, the problem storage unit 34 stores the plurality of predictive models. Here, the objective function generation unit 39 may read, from the storage unit 33, the plurality of predictive models to be applied to the mathematical programming problem stored in the problem storage unit 34, and generate the objective function.

The optimization unit 37 performs objective optimization based on the received various information. In detail, the optimization unit 37 optimizes the value of the objective variable so that the value of the objective function is optimal. Since each type of constraint condition is set for the objective variable and the like, the optimization unit 37 optimizes the value of the objective variable so that the value of the objective function is optimal (maximum, minimum, etc.), while satisfying the constraint conditions.

In this exemplary embodiment, the optimization unit 37 can be regarded as solving the mathematical programming problem so as to optimize the value of the objective function having the predictive model as a parameter as mentioned above. For example, the optimization unit 37 may optimize the prices of the plurality of products by solving the mathematical programming problem specified in the foregoing Formula 3. In the case where a constraint condition has the predictive model as an argument, the optimization unit 37 can be regarded as calculating the objective variable that optimizes the objective function under this constraint condition.

The output unit 38 outputs the optimization result by the optimization unit 37.

The predictive model input unit 31, the external information input unit 32, the constraint condition input unit 35, the optimization unit 37, the output unit 38, and the objective function generation unit 39 are realized by a CPU of a computer operating according to a program (information processing program or optimization program). For example, the program may be stored in the storage unit 33 in the optimization device 30, with the CPU reading the program and, according to the program, operating as the predictive model input unit 31, the external information input unit 32, the constraint condition input unit 35, the optimization unit 37, the output unit 38, and the objective function generation unit 39.

Alternatively, the predictive model input unit 31, the external information input unit 32, the constraint condition input unit 35, the optimization unit 37, the output unit 38, and the objective function generation unit 39 may each be realized by dedicated hardware. The predictive model input unit 31, the external information input unit 32, the constraint condition input unit 35, the optimization unit 37, the output unit 38, and the objective function generation unit 39 may each he realized by electric circuitry. The term “circuitry” here conceptually covers single device, multiple devices, chipset, and cloud. The optimization system according to the present invention may be realized by two or more physically separate devices that are connected wiredly or wirelessly.

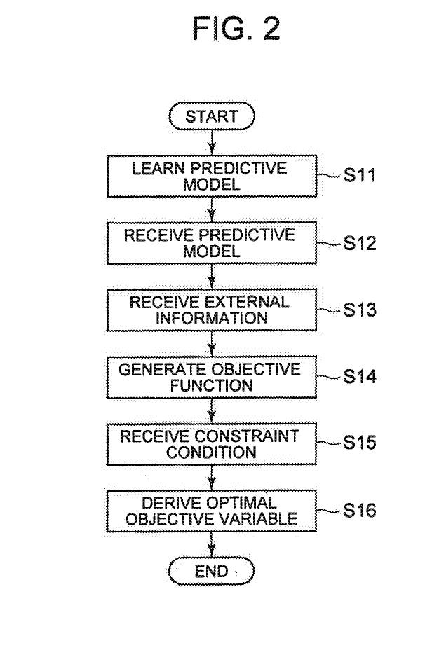

The operation of the optimization system in this exemplary embodiment is described below. FIG. 2 is a flowchart depicting an example of the operation by the optimization system in this exemplary embodiment. First, the learner 20 learns a predictive model for each set explained variable, based on each type of training data stored in the training data storage unit 10 (step S11).

The predictive model input unit 31 receives the predictive model venerated by the learner 20 (step S12), and stores the predictive model in the storage unit 33. The external information input unit 32 receives external information (step S13), and stores the external information in the storage unit 33.

The objective function generation unit 39 reads one or more predictive models received by the predictive model input unit 31 and a mathematical programming problem stored in the problem storage unit 34. The objective function generation unit 39 then generates an objective function of the mathematical programming problem (step S14). The constraint condition input unit 35 receives a constraint condition in optimization (step S15).

The optimization unit 37 optimizes the value of the objective variable so that the value of the objective function is optimal, under the received constraint condition (step S16).

As described above, in this exemplary embodiment, the predictive model input unit 31 receives a predictive model that is learned based on an explained variable and an explanatory variable, indicates the relationship between the explained variable and the explanatory variable, and is represented by a function of the explanatory variable. The optimization unit 37 calculates, for an objective function having the received predictive model as an argument, an objective variable that optimizes the objective function, under a constraint condition.

In detail, the objective function generation unit 39 defines the objective function of the mathematical programming problem using the predictive model as an argument, and the optimization unit 37 optimizes the value of the objective variable so as to maximize the value of the objective function of the mathematical programming problem, under the constraint condition having the predictive model as an argument. With such a structure, appropriate optimization can be performed even in a situation where there is unobservable input data in mathematical optimization.

This exemplary embodiment describes the method of optimizing the prices of the plurality of products so as to maximize the total sales revenue. Alternatively, the optimization unit 37 may optimize the prices of the plurality of products so as to maximize the profit.

Application examples of Exemplary Embodiment 1 are described below using simple specific examples, to facilitate the understanding of Exemplary Embodiment 1. First, an example of optimizing, based on sales prediction for a plurality of products, the prices of the plurality of products so as to maximize the total sales revenue of the plurality of products is described below as a first application example.

For example, consider the case of maximizing the total sales revenue of a sandwich group for the next month in a retail store. The sandwich group includes four types of sandwiches: sandwiches A, B, C, and D. In this case, a problem of optimizing the sales price of each of sandwiches A, B, C, and D so as to maximize the total sales revenue of the sandwich group, i.e. the total sales revenue of the four types of sandwiches of sandwiches A, B, C, and D, is to be solved.

The training data storage unit 10 stores data indicating the past sales revenue of each sandwich and the past sales price of each sandwich. The training data storage unit 10 may store external information such as weather and calendar information.

The learner 20 learns, for example, a predictive model for predicting the sales amount of each sandwich by machine learning, based on each type of training data stored in the training data storage unit 10.

A predictive model for predicting the sales amount of sandwich A is described below, as an example. The sales amount of sandwich A is expected to be influenced by the sales price of sandwich A. The sales amount of sandwich A is expected to be also influenced by the sales prices of the sandwiches displayed together with sandwich A on the product shelves, namely, sandwiches B, C, and D. This is because customers who visit the retail store are likely to selectively purchase a favorable sandwich from among sandwiches A, B, C, and D displayed together on the product shelves.

In such a situation, for example, suppose there is a day when sandwich B is sold at a greatly reduced price. Even a customer who usually prefers sandwich A may select and purchase not sandwich A but sandwich B in such a day. Given that the amount of sandwich a customer (person) can eat at one time is limited, a typical customer is unlikely to purchase both sandwiches A and B.

In such a case, selling sandwich B at a reduced price results in a decrease in the sales amount of sandwich A. This relationship is called cannibalization (market cannibalization).

In other words, cannibalization is such a relationship in which reducing the price of a product increases the sales amount of the product but decreases the sales amount of other competing products (a plurality of products similar in property or feature).

Therefore, the predictive model for predicting sales amount S_{A} (explained variable) of sandwich A can be represented, for example, as a function including price P_{A} of sandwich A, price P_{B} of sandwich B, price P_{C} of sandwich C, and price P_{D} of sandwich D as explanatory variables.

The learner 20 generates each of a predictive model for predicting sales amount S_{A} of sandwich A, a predictive model for predicting sales amount S_{B} of sandwich B, a predictive model for predicting sales amount S_{C} of sandwich C, and a predictive model for predicting sales amount S_{D} of sandwich D, based on each type of training data stored in the training data storage unit 10.

Here, based on the assumption that the sales of sandwiches is influenced by external information (weather, temperature, etc.), each predictive model may be generated while also taking these external information into account. Moreover, the predictive model may be generated while taking the passage of time into account. The predictive model is, for example, represented by the foregoing Formula 1 or 2.

As is clear from the above description, the predictive model is learned based on the explained variable (the sales amount of a sandwich in this exemplary embodiment) and the explanatory variable (the sales price of the sandwich, the sales prices of its competing sandwiches, etc. in this exemplary embodiment), indicates the relationship between the explained variable and the explanatory variable, and is represented by a function of the explanatory variable.

The optimization device 30 performs objective optimization, i.e. optimization of each of the respective sales prices (i.e. P_{A}, P_{B}, P_{C}, and P_{D}) of sandwiches A, B, C, and D. In detail, the optimization device 30 optimizes the value of the objective variable (i.e. P_{A}, P_{B}, P_{C}, and P_{D}) so as to maximize the value of the objective function (i.e. the total sales revenue of the sandwich group), while satisfying each type of constraint condition set for the objective variable (i.e. P_{A}, P_{B}, P_{C}, and P_{D}), etc. The objective function is represented by the foregoing Formula 3 as an example.

This application example is an example in which the objective function is defined using the predictive model as an argument, where the objective function (i.e. the total sales revenue of the sandwich group) handled by the optimization device 30 can be represented by the foregoing Formula 3.

Suppose the optimization device 30 stores the “form” of objective function represented by the foregoing Formula 3 beforehand. The optimization device 30 generates the objective function of the optimization problem, by assigning the predictive model generated by the learner 20 (i.e. the predictive model for predicting S_{A}, the predictive model for predicting S_{B}, the predictive model for predicting S_{C}, and the predictive model for predicting S_{D}) to the “form” of objective function.

The optimization device 30 calculates, for the objective function having the predictive model as an argument, the value of the objective variable (i.e. the values of P_{A}, P_{B}, P_{C}, and P_{D}) that optimizes the objective function under the constraint condition. An application example of Exemplary Embodiment 1 has been described above using a simple specific example. Although the above describes the case where the sales price of each individual product is optimized so as to maximize the total sales revenue of only four products for simplicity's Sake, the number of optimization targets is not limited to four, and may be two, three, or five or more. Moreover, the prediction target is not limited to a product, and may be a service or the like.

Next, consider the case of handling a problem of optimizing the sales price of each individual product so as to maximize the total sales amount of a large volume of products in an actual retail store. Manually defining an objective function of such a mathematical programming problem (optimization problem) is too complicated and is not practical.

For example, if a future demand predictive line of each product in the retail store is obtained, it is possible to optimize order and stock based on the demand. However, the number of products for which a demand predictive line can be drawn manually is limited. Besides, it is not practical to repeat demand prediction upon each order that takes place once in several hours. For example, to optimize the price of each product for a future period so as to maximize the sales in the period, a complex correlation between the price and demand of a large volume of products needs to be recognized, but manually doing so is difficult.

By such design that defines the “form” of objective function beforehand and defines an actual objective function using a predictive model as an argument as in the foregoing application example, an objective function of the mathematical programming problem can be efficiently generated even in a situation where there is massive unobservable input data in mathematical optimization. Moreover, in this exemplary embodiment, appropriate optimization can be performed even in a situation where there is a complex correlation between massive data as in the case of cannibalization.

Other than determining the price of each product so as to maximize the sales or profit of the product, the optimization system in this exemplary embodiment may be applied to, for example, optimization of shelving allocation for products. In this case, for example, the learner 20 learns a predictive model of sales amount Sₘ of product m by a linear regression model, as follows. Here, P is a product price, H is a shelf position, and θₘ is a parameter.

Sₘ=linear_regression(P, H, θₘ)

The optimization device 30 then optimizes P and H so as to maximize the sales (specifically, the sum of the multiplication results of price Pₘ and sales amount Sₘ of product m). Any business constraint (e.g. price condition, etc.) may be set in this case, too.

Other than such shelving allocation, the optimization method according to the present invention is also applicable to optimization of an objective function represented by the multiplication result of the price of each commercial material (including both service and product) and the demand (function of the price of each of multiple commercial materials) of the commercial material in retail price optimization, hotel room price optimization, plane ticket price optimization, parking fee optimization, campaign optimization, and the like.

Following the foregoing first application example, application examples of Exemplary Embodiment 1 in these cases are described below using simple specific examples. As a second application example, hotel price optimization is described below. In this application example, since an objective is to maximize sales revenue or profit, an objective function is represented by a function for calculating sales revenue or profit. An objective variable is, for example, package rate setting for each room of a hotel. In comparison with the above-mentioned retail, for example, “sandwich” in the retail corresponds to “bed and breakfast package of single room” in this application example. External information is, for example, weather, season, any event held near the hotel, etc.

As a third application example, hotel price and stock optimization is described below. In this application example, too, since an objective is to maximize sales revenue or profit, an objective function is represented by a function for calculating sales revenue or profit. An objective variable is selected that takes price and stock into account. For example, a first objective variable is a variable indicating, for each package, when and how much a room in the package is sold, and a second objective variable is a variable indicating, for each package, when and how many rooms in the package are sold. External information is, for example, weather, season, any event held near the hotel, etc., as in the second application example.

As a fourth application example, plane ticket price and stock optimization is described below. In this application example, too, since an objective is to maximize sales revenue or profit, an objective function is represented by a function for calculating sales revenue or profit. An objective variable is selected that takes price and stock into account, as in the third application example. Suppose each plane ticket represents the route to the destination and the seat type (class). For example, a first objective variable is a variable indicating, for each plane ticket, when and how much the plane ticket is sold, and a second, objective variable is a variable indicating, for each plane ticket, when and how many tickets are sold. External information is, for example, season, any event held, etc.

As a fifth application example, optimization of the parking fee of each parking lot is described below. In this application example, too, since an objective is to maximize sales revenue or profit, an objective function is represented by a function for calculating sales revenue or profit. An objective variable is, for example, a time and a location-specific parking fee. External information is, for example, the parking fee of a nearby parking lot, location information (residential area, business district, the distance from a station, etc.).

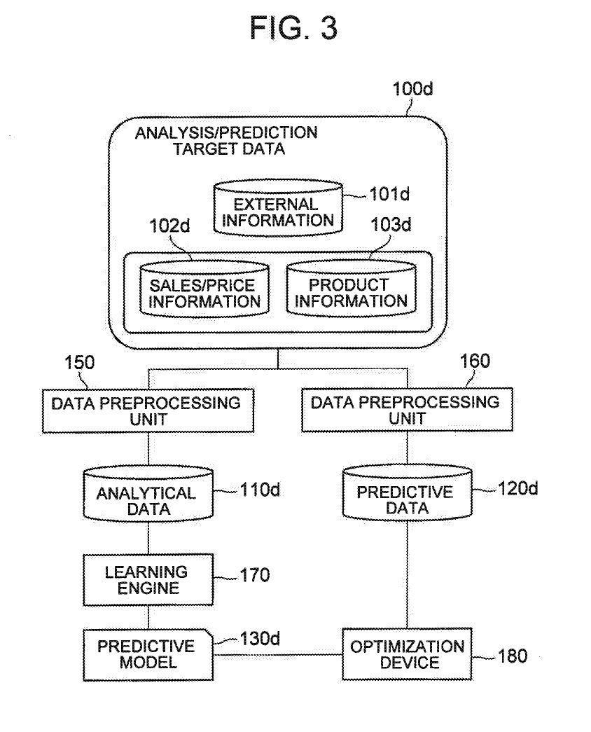

A modification of the optimization system in Exemplary Embodiment 1 is described below based on the flow of a predictive model and data (predictive data) necessary for prediction, in comparison with the structure depicted in FIG. 1. FIG. 3 is an explanatory diagram depicting an example of the structure of an optimization system in this modification.

The optimization system depicted in FIG. 3 includes a data preprocessing unit 150, a data preprocessing unit 160, a learning engine 170, and an optimization device 180. The data preprocessing units 150 and 160 each have a function of performing general processes such as filling a missing value for each data. The learning engine 170 corresponds to the learner 20 in Exemplary Embodiment 1. The optimization device 180 corresponds to the optimization device 30 in Exemplary Embodiment 1.

First, analytical data 110d and predictive data 120d are generated from analysis/prediction target data 100d. The analysis/prediction target data 100d includes, for example, external information 101d such as weather and calendar data, sales/price information 102d, and product information 103d.

The analytical data 110d is data used by:the learning engine 170 for learning, and corresponds to data stored in the training data storage unit 10 in Exemplary Embodiment 1. The predictive data 120d is external data and other data necessary for prediction, and is specifically a value of an explanatory variable in a predictive model. The predictive data 120d corresponds to part or whole of data stored in the storage unit 33 in Exemplary Embodiment 1.

In the example depicted in FIG. 3, the data preprocessing unit 150 generates the analytical data 110d from the analysis/prediction target data 100d, and the data preprocessing unit 160 generates the predictive data 120d from the analysis/prediction target data 100d.

The learning engine 170 performs learning using the analytical data 110d, and outputs a predictive model 130d. The optimization device 180 receives the predictive model 130d and the predictive data 120d, and performs an optimization process.

Each type of data (analysis/prediction target data 110d (i.e. external information 101d, sales/price information 102d, and product information 103d), analytical data 110d, and predictive data 120d) depicted in FIG. 3 is, for example, held in a database of a storage unit (not depicted) in the optimization system.

An objective function subjected to optimization is defined using a predictive model as an argument, as described in Exemplary Embodiment 1. Moreover, predictive data is also input data for optimization, as depicted in FIG. 3. The present invention is thus characterized in that a predictive model and predictive data are input for optimization, as depicted in FIG. 3.

### Exemplary Embodiment 2

Exemplary Embodiment 2 of an optimization system according to the present invention is described below. Exemplary Embodiment 1 describes a method of machine learning a model for predicting unobservable data from past data, automatically generating an objective function of mathematical programming and a constraint condition based on a future prediction result obtained based on the predictive model, and performing optimization.

In a process of performing such optimization, there are instances where the predictive model based on machine learning is based on a non-linear basis function, as mentioned earlier. For example, consider the case of performing, for the above-mentioned price prediction problem, non-linear transformation such as squaring of price and logarithmic transformation of price as a feature value input to the predictive model based on machine learning. In this case, the objective function (sales for a future period) of mathematical optimization is a function of the feature value obtained by complex non-linear transformation of the price, so that efficiently solving such mathematical optimization using a typical method is difficult.

Accordingly, Exemplary Embodiment 2 describes a method that can solve mathematical optimization at high speed with high accuracy even in the case where a predictive model used for optimization is based on a non-linear basis function.

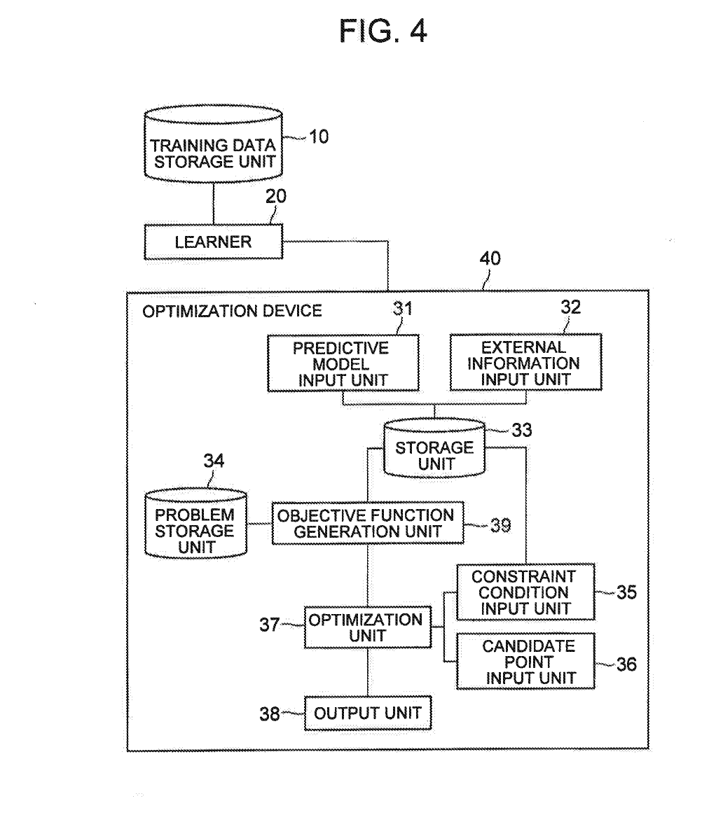

FIG. 4 is a block diagram depicting an example of the structure of Exemplary Embodiment 2 of an optimization system according to the present invention. The optimization system in this exemplary embodiment includes the training data storage unit 10, the learner 20, and an optimization device 40. The optimization system depicted in FIG. 4 corresponds to the information processing system according to the present invention. The training data storage unit 10 and the learner 20 are the same as those in Exemplary Embodiment 1.

The optimization device 40 includes the predictive model input unit 31, the external information input unit 32, the storage unit 33, the problem storage unit 34, the constraint condition input unit 35, a candidate point input unit 36, the optimization unit 37, the output unit 38, and the objective function generation unit 39.

The optimization device 40 is a device that performs objective optimization, as in Exemplary Embodiment 1. The optimization device 40 differs from the optimization device 30 in Exemplary Embodiment 1 in that the candidate point input unit 36 is further included. The optimization unit 37 in this exemplary embodiment performs optimization while also taking the input of the candidate point input unit 36 into account. The other components are the same as those in Exemplary Embodiment 1.

The candidate point input unit 36 receives a candidate point of optimization. A candidate point is a discrete value that is a candidate for an objective variable. In the above-mentioned example, price candidates (e.g. no discount, 5% discount, 7% discount, etc.) are candidate points. Input of such a candidate point can reduce the optimization cost.

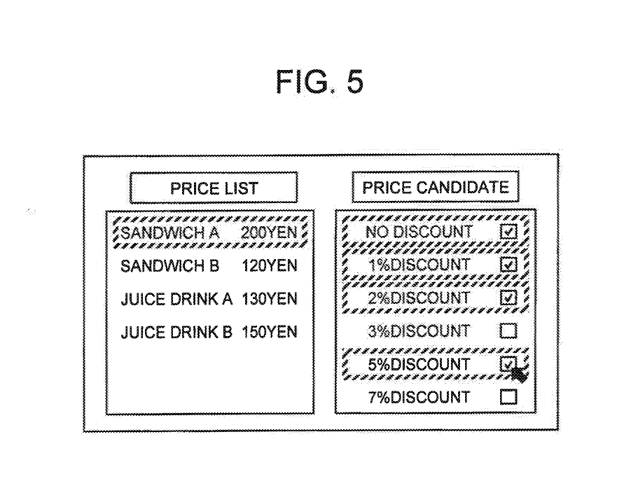

FIG. 5 is an explanatory diagram depicting an example of a screen for the candidate point input unit 36 receiving input of candidate points from the user. In the example depicted in FIG. 5, the candidate point input unit 36 displays a list of the prices of products used in a linear regression model on the left side, and a list of price candidates set for the price of each product on the right side. Thus, the candidate point input unit 36 displays a list of objective variables subjected to optimization and candidates for a value that can be taken by each objective variable, and receives a selected objective variable candidate.

In the example depicted in FIG. 5, the operator sets four candidates: no discount, 1% discount, 2% discount, and 5% discount, as candidates for the price of sandwich A (200 yen). Although discount information is displayed as objective variable candidates in the example depicted in FIG. 5, the candidate point input unit 36 may display actual price candidate values (e.g. candidate values such as 190 yen, 200 yen, 210 yen, and 220 yen).

A mathematical programming problem in the case where one or more candidate points are input is described below, using a specific example. Here, an optimization object index set is denoted as {k|k=1, . . . , K}. In the above-mentioned example, K corresponds to the number of price candidates. For example, in the case where there are four price candidates “no discount, 1% discount, 2% discount, and 5% discount” for the product “sandwich A”, K=4. An optimization object candidate set for product m is denoted as overlined Pₘₖ, as written below, In the above-mentioned example, overlined Pₘₖ indicates a price candidate for product m.

{P̅ₘₖ} [Math. 4]

The k-th indicator of m is denoted as Zₘₖ. Zₘₖ satisfies the following condition.

Zₘₖ∈{1,0} where Σ^{K}ₖ₌₁Zₘₖ=1 [Math. 5]

With such definition, price P, of product m is defined in the following Formula 4. This definition indicates that price Pₘ which is an objective variable is discretized.

$$\begin{matrix}[ Math . 6 ] & \\ {P}_{m} = {\sum }_{k = 1}^{K} {Z}_{mk} {\overline{P}}_{mk} & ( Formula 4 )\end{matrix}$$

The foregoing Formula 1 can then be modified as follows.

$$\begin{matrix}{S}_{m} = {α}_{m} + {\sum }_{{m}^{′} = 1}^{M} {\sum }_{d = 1}^{D} {β}_{m {m}^{′}}^{d} {f}_{d} ( {\sum }_{k = 1}^{K} {Z}_{{m}^{′} k} {\overline{P}}_{{m}^{′} k} ) + \\ {\sum }_{d = 1}^{{D}^{′}} {γ}_{d}^{m} {g}_{d} \\ = {α}_{m} + {\sum }_{{m}^{′} = 1}^{M} {\sum }_{d = 1}^{D} {β}_{m {m}^{′}}^{d} {\sum }_{k = 1}^{K} {Z}_{{m}^{′} k} {f}_{d} ( {\overline{P}}_{{m}^{′} k} ) + \\ {\sum }_{d = 1}^{{D}^{′}} {γ}_{d}^{m} {g}_{d} \\ = {α}_{m} + {\sum }_{{m}^{′} = 1}^{M} {\sum }_{k = 1}^{K} {Z}_{{m}^{′} k} {\sum }_{d = 1}^{{D}^{′}} {β}_{m {m}^{′}}^{d} {f}_{d} ( {\overline{P}}_{{m}^{′} k} ) + \\ {\sum }_{d = 1}^{{D}^{′}} {γ}_{d}^{m} {g}_{d} \\ = {α}_{m} + {\sum }_{{m}^{′} = 1}^{M} {\sum }_{k = 1}^{K} {Z}_{{m}^{′} k} {F}_{m {m}^{′}}^{k} + {\sum }_{d = 1}^{{D}^{′}} {γ}_{d}^{m} {g}_{d}\end{matrix} \qquad [ Math . 7 ]$$

where F^{k}_{mm′}=Σ^{D}_{d=1}β^{d}_{mm′}f_{d}(P̅_{m′k})

Moreover, the foregoing Formula 3 can be modified as shown in the following Formula 5, where Z=(Z₁₁, . . . , Z_{1K}, . . . , Z_{MK}).

$$\begin{matrix}[ Math . 8 ] & \\ {max}_{Z} {\sum }_{t ∈ {T}_{te}} {\sum }_{m = 1}^{M} {P}_{m} {S}_{m}^{( t )} \\ s . t . {\sum }_{k = 1}^{K} {Z}_{ mk} = 1. \\ {Z}_{mk} ∈ \{ 1 , 0 \} & ( Formula 5 )\end{matrix}$$

For example, in the case where no candidate point is input, the optimization unit 37 may optimize the prices of the plurality of products by solving the mathematical programming problem defined in the foregoing Formula 3. In the case where a candidate point is input, the optimization unit 37 may optimize the prices of the plurality of products by solving the mathematical programming problem defined in the foregoing Formula 5.

Here, the constraint condition input unit 35 may receive input that takes a candidate point into account. A specific example of a constraint condition set in the above-mentioned product optimization is given below. Typically, when comparing the price of a single ballpoint pen and the price of a set of six ballpoint pens of the same brand, the price of per one ballpoint pen in a set of six ballpoint pens is expected to be lower than the price of a single ballpoint pen. This type of constraint condition is defined in the following Formula 6.

$$\begin{matrix}[ Math . 9 ] & \\ {\sum }_{i = mK + 1}^{mK + K} {Z}_{mi} {\overline{P}}_{mi} \leq {ω}_{mn} {\sum }_{i = nK + 1}^{nK + K} {Z}_{ni} {\overline{P}}_{ni} ∀ ( m , n ) ∈ 𝒫𝒞 & ( Formula 6 )\end{matrix}$$

In Formula 6, PC denotes a set of index pairs to which the constraint condition is applied, and w_{m,n} denotes a weight. PC and w_{m,n} are given beforehand.

A specific example of the optimization process performed by the optimization unit 37 is described below, using the foregoing Formula 5. In the case of the foregoing Formula 5, the objective function can be modified as follows.

$$\begin{matrix} [ Math . 10 ] & \\ \begin{matrix}{\sum }_{t ∈ {T}_{te}} {\sum }_{m = 1}^{M} {P}_{m} {S}_{m}^{( t )} = {\sum }_{t ∈ {T}_{te}} {\sum }_{m = 1}^{M} ( {\sum }_{k = 1}^{K} {Z}_{mk} {\overline{P}}_{mk} ) \\ ( {α}_{m}^{( t )} + {\sum }_{{m}^{′} = 1}^{M} {\sum }_{k = 1}^{K} {Z}_{{m}^{′} k} {F}_{m {m}^{′}}^{k ( t )} + {\sum }_{d = 1}^{{D}^{′}} {γ}_{d}^{m ( t )} {g}_{d} ) \\ = {\sum }_{t ∈ {T}_{te}} {\sum }_{m = 1}^{M} ( ( {\sum }_{k = 1}^{K} {Z}_{mk} {\overline{P}}_{mk} ) \\ ( {\sum }_{{m}^{′} = 1}^{M} {\sum }_{{k}^{′} = 1}^{K} {Z}_{{m}^{′} {k}^{′}} {F}_{m {m}^{′}}^{{k}^{′} ( t )} ) + \\ ( {α}_{m}^{( t )} + {\sum }_{d = 1}^{{D}^{′}} {γ}_{d}^{m ( t )} {g}_{d} ) ) \\ = {\sum }_{t ∈ {T}_{te}} \{ {\sum }_{m = 1}^{M} {\sum }_{{m}^{′} = 1}^{M} {\sum }_{k = 1}^{K} {\sum }_{{k}^{′} = 1}^{K} {\overline{P}}_{mk} {F}_{m {m}^{′}}^{{k}^{′} ( t )} {Z}_{mk} {Z}_{{mk}^{′}} + \\ {\sum }_{m = 1}^{M} {\sum }_{k = 1}^{K} ( {α}_{m}^{( t )} + {\sum }_{d = 1}^{{D}^{′}} {γ}_{d}^{m ( t )} {g}_{d} ) {\overline{P}}_{mk} {Z}_{mk} \} \\ = {Z}^{T} QZ + {r}^{T} Z\end{matrix} & ( Formula A )\end{matrix}$$

where

|Q|_{mk,m′k′}=Σ_{t∈T}_{ₜₑ}PₘₖF^{k′(t)}_{mm′}, [r]ₘₖ=Σ_{t∈T}_{ₜₑ}(α^{(t)}ₘ+Σ^{D′}_{d=1}Γ^{m(t)}_{d}g_{d})P̅ₘₖ

Here, [Q]_{i,j} is the (i,j)-th element of matrix Q, and [r]₁ is the i-th element of vector r. Hence, the above-mentioned Q is not a symmetric matrix, and is not positive semidefinite. This problem is a sort of mixed integer quadratic programming problem called nonconvex cardinality (0-1 integer) quadratic programming. This problem is efficiently solved by transforming the problem into a mixed integer linear programming.

A method for solving the mathematical programming problem defined in the foregoing Formula 5 using mixed integer programming relaxation is described below. A modification process shown in the following Formula 7 is performed using new overlined variable Z_{i,j}.

$$\begin{matrix}[ Math . 11 ] & \\ max {\sum }_{i = 1}^{KM} ( {[ r ]}_{i} + {[ Q ]}_{i , i} ) {Z}_{i} + {\sum }_{i = 1}^{KM} {\sum }_{j = i + 1}^{KM} ( {[ Q ]}_{i , j} + {[ Q ]}_{j , i} ) {\overline{Z}}_{i , j} \\ s . t . {\sum }_{i = mK + 1}^{mK + K} {Z}_{i} = 1 ∀ m = 0 , … , M - 1 \\ {\overline{Z}}_{ij} \geq {Z}_{i} + {Z}_{j} - 1 ∀ i < j \\ {\overline{Z}}_{ij} \leq {Z}_{i} ∀ i < j \\ {\overline{Z}}_{ij} \leq {Z}_{j} ∀ i < j \\ {\overline{Z}}_{ij} \geq ∀ 1 \leq i \leq j \\ {Z}_{i} ∈ \{ 0 , 1 \} ∀ i & ( Formula 7 )\end{matrix}$$

Here, a constraint in the following Formula 8 that overlined variable Z_{i,j} takes in an optimal solution is defined.

$$\begin{matrix} [ Math . 12 ] & \\ {\sum }_{i = mK + 1}^{j} {\overline{Z}}_{i , j} + {\sum }_{i = j + 1}^{mK + K} {\overline{Z}}_{i , j} = {\sum }_{i = mK + 1}^{mK + K} {Z}_{i} {Z}_{j} - {Z}_{j} = ( {\sum }_{i = mK + 1}^{mK + K} {Z}_{i} - 1 ) {Z}_{j} = 0 & ( Formula 8 )\end{matrix}$$

Adding the equality shown in the foregoing Formula 8 allows the foregoing Formula 7 to be newly formulated as shown in the following Formula 9.

$$\begin{matrix}[ Math . 13 ] & \\ max {\sum }_{i = 1}^{KM} ( {[ r ]}_{i} + {[ Q ]}_{i , i} ) {Z}_{i} + {\sum }_{i = 1}^{KM} {\sum }_{j = i + 1}^{KM} ( {[ Q ]}_{i , j} + {[ Q ]}_{j , i} ) {\overline{Z}}_{i , j} \\ s . t . {\sum }_{i = mK + 1}^{mK + K} {Z}_{i} = 1 ∀ m = 0 , … , M - 1 \\ {\overline{Z}}_{ij} \geq {Z}_{i} + {Z}_{j} - 1 ∀ i < j \\ {\overline{Z}}_{ij} \leq {Z}_{i} ∀ i < j \\ {\overline{Z}}_{ij} \leq {Z}_{j} ∀ i < j \\ {\sum }_{i = mK + 1}^{j} {\overline{Z}}_{i , j} + {\sum }_{i = j + 1}^{mK + K} {\overline{Z}}_{i , j} = 0 \\ ∀ mK \leq j \leq mK + K , \\ ∀ m = 0 , … , M - 1 \\ {\overline{Z}}_{ij} \geq 0 ∀ 1 \leq i \leq j \\ {Z}_{i} ∈ \{ 0 , 1 \} ∀ i & ( Formula 9 )\end{matrix}$$

To reduce the number of constraint conditions for more efficient calculation, the following inequality may be deleted from the condition of the foregoing Formula 9.

Z̅ᵢⱼ≥Zᵢ+Zⱼ−1 [Math. 14]

The optimization unit 37 optimizes the prices of the plurality of products so as to maximize such modified formula. In the case where the candidate point input unit 36 receives no candidate point, the optimization unit 37 may solve the mathematical programming problem in the foregoing Formula 3. The constraint condition in the foregoing Formula 6 may be applied in mixed integer linear programming (MILP) relaxation.

The predictive model input unit 31, the external information input unit 32, the constraint condition input unit 35, the candidate point input unit 36, the optimization unit 37, the output unit 38, and the objective function generation unit 39 are realized by a CPU of a computer operating according to a program (information processing program or optimization program).

Alternatively, the predictive model input unit 31, the external information input unit 32, the constraint condition input unit 35, the candidate point input unit 36, the optimization unit 37, the output unit 38, and the objective function generation unit 39 may each be realized by dedicated hardware. The predictive model input unit 31, the external information input unit 32, the constraint condition input unit 35, the candidate point input unit 36, the optimization unit 37, the output unit 38, and the objective function generation unit 39 may each be realized by electric circuitry.

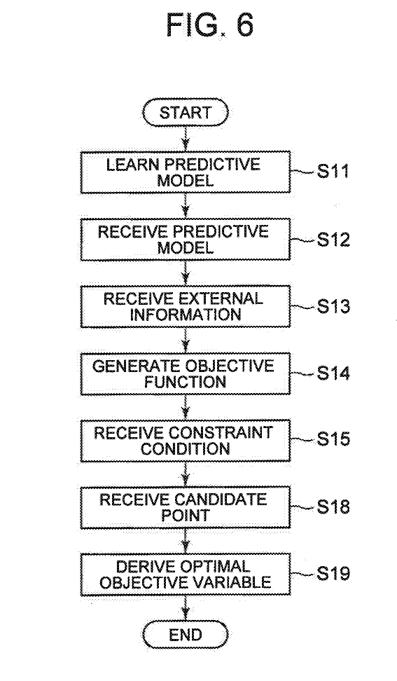

The operation by the optimization system in this exemplary embodiment is described below. FIG. 6 is a flowchart depicting an example of the operation by the optimization system in this exemplary embodiment. The process from step S11 to step S15 of receiving a learned model and external information, generating an objective variable, and receiving a constraint condition is the same as that in FIG. 2.

The candidate point input unit 36 receives a candidate point which is a candidate for a value that can be taken by the objective variable (step S18). The number of candidate points received may be one or more. The optimization unit 37 then optimizes the value of the objective variable so that the value of the objective function is optimal, under the received candidate point and constraint condition (step S19).

Thus, this exemplary embodiment describes the optimization system that optimizes the value of an objective variable so that the value of an objective function of a mathematical programming problem is optimal. In detail, the predictive model input unit 31 receives a linear regression model represented by a function having the objective variable of the mathematical programming problem as an explanatory variable. The candidate point input unit 36 receives, for the objective variable included in the linear regression model, a discrete candidate (candidate point) for the value that can be taken by the objective variable. The optimization unit 37 then calculates the objective variable that optimizes the objective function of the mathematical programming problem having the linear regression model as an argument. Here, the optimization unit 37 selects a candidate point that optimizes the objective variable, to calculate the objective variable.

With such a structure, mathematical optimization can be solved at high speed with high accuracy even in the case where a predictive model used for optimization is based on a non-linear basis function.

In detail, the optimization unit 37 optimizes an objective function having, as a parameter, a predictive model represented by the linear regression equation in the foregoing Formula 1. Here, the linear regression equation in Formula 1 has at least part of the explanatory variable represented by non-linear function f_{d}.

For example, even for an objective variable, such as price, for which all kinds of candidates can be assumed, actual optimization is often performed by setting certain price candidates beforehand. Predictive model Sₘ represented in the form of the foregoing Formula I results from applying function f_{d} to objective variable Pₘ which is an optimization target. In the case where an explanatory variable is represented by non-linear function f_{d}, even a function represented in the form of linear regression equation is a non-linear function as far as price is concerned, and so its optimization is difficult.

In this exemplary embodiment, however, by discretizing an objective variable to provide a candidate point, a non-linear formula relating to an objective function of optimization can be modified to a linear formula relating to discrete variable Z_{d}, regardless of f_{d}. In other words, the optimization process can be performed at high speed for a linear regression equation that is expressed as linear regression but is non-linearly transformed, by setting an objective variable of optimization (e.g. provided by a person) beforehand.

The use of the method in this exemplary embodiment also enables application of a method in the below-mentioned Exemplary Embodiment 3, so that the optimization process can be performed at high speed.

This exemplary embodiment describes the method of optimizing the prices of the plurality of products so as to maximize the total sales revenue. Alternatively, the optimization unit 37 may optimize the prices of the plurality of products so as to maximize the profit. In this case, the objective function generation unit 39 may generate the following objective function as an example, where c is a term that does not depend on Z.

$$\begin{matrix}{\sum }_{t ∈ {T}_{te}} {\sum }_{m = 1}^{M} ( {P}_{m} - {C}_{m} ) {S}_{m}^{( t )} = {\sum }_{t ∈ {T}_{te}} {\sum }_{m = 1}^{M} {P}_{m} {S}_{m}^{( t )} - \\ {\sum }_{t ∈ {T}_{te}} {\sum }_{m = 1}^{M} {C}_{m} {S}_{m}^{( t )} \\ = {Z}^{T} QZ + {r}^{T} Z - {\sum }_{t ∈ {T}_{te}} {\sum }_{m = 1}^{M} {C}_{m} \\ ( {α}_{m}^{( t )} + {\sum }_{{m}^{′} = 1}^{M} {\sum }_{k = 1}^{K} {Z}_{{m}^{′} k} {F}_{m {m}^{′}}^{k ( t )} + \\ {\sum }_{d = 1}^{{D}^{′}} {γ}_{d}^{m ( t )} {g}_{d} ) \\ = {Z}^{T} QZ + {( r - F )}^{T} Z + c \\ = {Z}^{T} QZ + {\overline{r}}^{T} Z + c\end{matrix} \qquad [ Math . 15 ]$$

where

[F]_{m′k}=Σ_{t∈T}_{ₜₑ}Σ^{M}ₘ₌₁CₘF^{k(t)}_{mm′}

This objective function is again a nonconvex cardinality (0-1 integer) quadratic programming where c does not depend on Z, and so the above-mentioned solving method can be applied as a problem mathematically equivalent to the foregoing Formula A.

This exemplary embodiment describes the case of optimizing the sales revenue (price×sales amount) by subjecting the sales amount to regression, as in Exemplary Embodiment 1. Alternatively, not the sales amount but the sales revenue may he subjected to regression. In the case of directly subjecting the sales revenue to regression, the learner 20 learns the sales revenue by a regression equation based on non-linear transformation of a quadratic function of the objective variable. The regression equation in such a case is represented by the following Formula B1 as an example.

$$\begin{matrix}[ Math . 16 ] & \\ f ( x ) = {\sum }_{i = 1}^{n} {\sum }_{j = 1}^{n} {\sum }_{d = 1}^{D} {w}_{ijd} {φ}_{d} ( {x}_{i} , {x}_{j} ) + {\sum }_{i = 1}^{n} {\sum }_{d = 1}^{{D}^{′}} {υ}_{id} {ψ}_{d} ( {x}_{i} ) & ( Formula B1 )\end{matrix}$$

where ϕ_{d}: [symbol] ²→ [symbol] , ψ_{d}: [symbol] →

[symbol]

In Formula B1, φ_{d}, and ψ_{d} are each any basis function, and x corresponds to price. This function is set as the objective function of optimization. As in the foregoing Formula 4, x is discretized as shown in the following Formula B2.

$$\begin{matrix}[ Math . 17 ] & \\ {x}_{i} = {\sum }_{k = 1}^{{K}_{i}} {\overline{x}}_{ik} {z}_{ik} ( i = 1 , … , n ) & ( Formula B2 )\end{matrix}$$

After discretizing x in this way, the following modification can result in a BCP problem shown in the following Formula B3. Thus, the method in this exemplary embodiment can be used to perform optimization even in the case where the sales revenue is subjected to regression.

$$\begin{matrix} [ Math . 18 ] & \\ {g}_{ij} ( {x}_{i} , {x}_{j} ) = {\sum }_{d = 1}^{D} {w}_{ijd} {φ}_{d} ( {x}_{i} , {x}_{j} ) , \\ then {g}_{ij} ( {x}_{i} , {x}_{j} ) = {z}_{i}^{⊤} {Q}_{ij} {z}_{j} where & \\ {Q}_{ij} = \text{?} & \\ [ Math . 19 ] & \\ {h}_{i} ( {x}_{i} ) = {\sum }_{d = 1}^{{D}^{′}} {υ}_{id} {ψ}_{d} ( {x}_{i} ) , then \\ {h}_{i} ( {x}_{i} ) = [ {h}_{i} ( {\overline{x}}_{i 1} ) , {h}_{i} ( {\overline{x}}_{i 2} ) , … , {h}_{i} ( {\overline{x}}_{i} , {κ}_{i} ) ] \\ {z}_{i} = : {r}_{i}^{⊤} {z}_{i} where \\ r = [ \begin{matrix}{r}_{1} \\ {r}_{2} \\ ⋮ \\ {r}_{n}\end{matrix} ] & \\ [ Math . 20 ] & \\ \begin{matrix} Maximize & {z}^{⊤} Qz + {r}^{⊤} z \\ subject to & z = {[ {z}_{11} , … , {z}_{1} , {κ}_{1} , {z}_{21} , … , {z}_{n} {κ}_{n} ]}^{⊤} \\ & ∈ {\{ 0 , 1 \}}^{{\sum }_{i = 1}^{n} {K}_{i}} \\ & {\sum }_{k = 1}^{{K}_{i}} {z}_{ik} = 1 ( i = 1 , … , n ) .\end{matrix} \\ where & ( Formula B3 ) \\ Q = [ \begin{matrix}{Q}_{11} & {Q}_{12} & … & {Q}_{1 n} \\ {Q}_{21} & {Q}_{22} & … & {Q}_{2 n} \\ ⋮ & ⋮ & ⋱ & ⋮ \\ {Q}_{n 1} & {Q}_{n 2} & … & {Q}_{nn}\end{matrix} ] \\ \text{?} \text{indicates text missing or illegible when filed} & \end{matrix}$$

### Exemplary Embodiment 3

Exemplary Embodiment 3 of an optimization system according to the present invention is described below. A binary quadratic programming (BQP) problem is known as an optimization approach. Since the foregoing Formula A can be generated by applying discretization to linear prediction as described in Exemplary Embodiment 2, the problem in Exemplary Embodiment 2 can be transformed to BQP. BQP is an NP-hard problem, and is commonly known to be solved using a framework called integer programming because no exact solution is found.

Exemplary Embodiment 2 describes the method for solving BQP by mixed integer programming relaxation. This exemplary embodiment describes a method for solving BQP shown in the foregoing Formula A at higher speed. The optimization system in this exemplary embodiment has the same structure as the optimization system in Exemplary Embodiment 2, but differs from Exemplary Embodiment 2 in the method by which the optimization unit 37 performs the optimization process.

In detail, the optimization unit 37 in this exemplary embodiment relaxes BQP to an easy-to-solve problem called semidefinite programming (SDP) problem, and optimizes BQP based on the solution of SDP.

As an example, BQP is first formulated as shown in the following Formula 10. In Formula 10, M and K are natural numbers. Moreover, in Formula 10, Q is a KM×KM square matrix, and r is a KM-dimensional vector.

$$\begin{matrix}[ Math . 21 ] & \\ \begin{matrix}Maximize & {Z}^{T} QZ + {r}^{T} Z \\ subject to & Z = {[ {Z}_{1} … {Z}_{n} ]}^{T} ∈ {\{ 0 , 1 \}}^{n} , \\ & {\sum }_{k = 1}^{K} {Z}_{Km + k} = 1 ( m = 0 , … M - 1 )\end{matrix} & ( Formula 10 )\end{matrix}$$

Let Symₙ be a set of all symmetric matrices of size n. In detail, Symₙ is written as follows.

Symₙ={X∈ [symbol] ^{n×n}|X^{T}=X} [Math. 22]

A vector which is all 1 may be written as boldfaced 1, where boldfaced 1=(1, 1, . . . , 1)^{T}. The inner product on Symₙ is defined as follows, using a black dot sign.

X·Y=Σⁿᵢ₌₁Σⁿⱼ₌₁XᵢⱼYᵢⱼ for X,Y∈Symₙ [Math. 23]

The following Formula 11 holds for all vectors x. Accordingly, Q in the foregoing Formula 10 can be replaced with the following Formula 12. Q is therefore assumed to be a symmetric matrix, without loss of generality.

[Math. 24]

x^{T}Qx=x^{T}(Q+Q^{T})x/2 (Formula 11)

(Q+Q^{T})/2 (Formula 12)

An SDP relaxation method is described below. First, the optimization unit 37 transforms BQP in Formula 10 to a variable that takes {1, −1} value. Suppose t=−1+2Z. The foregoing Formula 10 is then modified to the following Formula 13.

$$\begin{matrix}[ Math . 25 ] & \\ \begin{matrix}{Z}^{T} QZ + {r}^{T} Z = \frac{1}{4} {( t + 1 )}^{T} Q ( t + 1 ) + \\ \frac{1}{2} {r}^{T} ( t + 1 ) \\ = \frac{1}{4} {t}^{T} Qt + \frac{1}{2} {( r + Q 1 )}^{T} t + \\ \frac{1}{4} ( {1}^{T} Q 1 + 2 {r}^{T} 1 ) \\ = [ 1 {t}^{T} ] A [ \begin{matrix}1 \\ t\end{matrix} ]\end{matrix} \\ where \\ A = \frac{1}{4} [ \begin{matrix}{1}^{T} Q 1 + 2 {r}^{T} 1 & {( r + Q 1 )}^{T} \\ r + Q 1 & Q\end{matrix} ] , A ∈ {Sym}_{KM + 1} & ( Formula 13 )\end{matrix}$$

The foregoing Formula 10 is thus equivalent to the following Formula 14.

$$\begin{matrix}[ Math . 26 ] & \\ \begin{matrix}Maximize & [ 1 {t}^{T} ] A [ \begin{matrix}1 \\ t\end{matrix} ] \\ subject to & t = {[ {t}_{1} , … , {t}_{KM} ]}^{T} ∈ {\{ - 1 , 1 \}}^{KM} , \\ & {\sum }_{k = 1}^{K} {t}_{Km + k} = - K + 2 , \\ & ( m = 0 , … , M - 1 )\end{matrix} & ( Formula 14 )\end{matrix}$$

Next, the optimization unit 37 relaxes each variable t₁ that takes S⁰={1, −1} value, to variable xᵢ that takes S^{KM} value. Sn represents the unit n-sphere, as shown in the following Formula 15.

[Math. 27]

Sⁿ={x∈ [symbol] ⁿ⁺¹|∥x∥₂=1} (Formula 15)

In this case, the foregoing Formula 14 is relaxed to the problem of the following Formula 16.

$$\begin{matrix}[ Math . 28 ] & \\ \begin{matrix}Maximize & tr ( [ {x}_{0} , {x}_{1} … {x}_{KM} ] A [ \begin{matrix}{x}_{0}^{T} \\ ⋮ \\ {x}_{KM}^{T}\end{matrix} ] ) \\ subject to & {x}_{i} ∈ {ℝ}^{KM + 1} , \\ & {‖ {x}_{i} ‖}_{2} = 1 ( i = 0 , 1 … KM ) , \\ & {\sum }_{k = 1}^{K} {x}_{Km + k} = ( - K + 2 ) {x}_{0} \\ & ( m = 0 … M - 1 )\end{matrix} & ( Formula 16 )\end{matrix}$$

Here, “1” in the objective function of the foregoing Formula 14 is equally replaced with unit vector x₀. For feasible solution t of the foregoing Formula 14, the feasible solution of Formula 16 is defined by the following Formula 17, with no contradiction of the value of the objective function. Hence, the problem of the foregoing Formula 16 is a result of relaxing the foregoing Formula 14.

[Math. 29]

x₀=[1, 0 . . . 0]^{T}, (Formula 17)

xᵢ=[tᵢ, 0 . . . 0]^{T} (i=1 . . . KM)

The optimization unit 37 transforms the problem of the foregoing Formula 16 to an SDP problem. The objective function in Formula 16 is transformed to the following Formula 18.

$$\begin{matrix}[ Math . 30 ] & \\ \begin{matrix}tr = ( [ {x}_{0} , {x}_{1} , … , {x}_{KM} ] A [ \begin{matrix}{x}_{0}^{T} \\ ⋮ \\ {x}_{KM}^{T}\end{matrix} ] ) \\ = A * [ \begin{matrix}{x}_{0}^{T} \\ ⋮ \\ {x}_{KM}^{T}\end{matrix} ] [ {x}_{0} , {x}_{1} , … , {x}_{KM} ] \\ = A * Y\end{matrix} \\ where \\ \begin{matrix}Y = [ \begin{matrix}{y}_{00} & {y}_{01} & … & {y}_{0 , KM} \\ {y}_{10} & {y}_{11} & … & {y}_{1 , KM} \\ ⋮ & ⋮ & ⋱ & ⋮ \\ {y}_{KM , 0} & {y}_{KM , 1} & … & {y}_{KM , KM}\end{matrix} ] \\ = [ \begin{matrix}{x}_{0}^{T} \\ {x}_{1}^{T} \\ ⋮ \\ {x}_{KM}^{T}\end{matrix} ] [ {x}_{0} , {x}_{1} , … , {x}_{KM} ]\end{matrix} \\ Y ∈ {Sym}_{KM + 1} & ( Formula 18 )\end{matrix}$$

According to this definition, Y is positive semidefinite;:and satisfies the following Formula 19.

[Math. 31]

yᵢⱼ=x^{T}ᵢxⱼ (i=0, 1, . . . KM, j=0, 1 . . . KM) (Formula 19)

If Y is positive semidefinite, (KM+1)-dimensional vectors x₀, xᵢ, . . . x_{KM} satisfy the condition defined in the foregoing Formula 18, and Formula 19.

Setting yᵢⱼ=1 using matrix Y enables constraint condition ∥xᵢ∥₂=1 to be expressed. Since x₀ is a unit vector, the following Formula 21 holds only in the case where the following Formula 20 is satisfied.

$$\begin{matrix}[ Math . 32 ] & \\ {x}_{0}^{T} {\sum }_{k = 1}^{K} {x}_{Km + k} = - K + 2 , \\ {‖ {\sum }_{k = 1}^{K} {x}_{Km + k} ‖}_{2}^{2} = {( - K + 2 )}^{2} & ( Formula 20 ) \\ {\sum }_{k = 1}^{K} {x}_{Km + k} = ( - K + 2 ) {x}_{0} & ( Formula 21 )\end{matrix}$$

Using matrix Y these conditions can be expressed as shown in the following Formula 22.

$$\begin{matrix}[ Math . 33 ] & \\ {\sum }_{k = 1}^{K} {y}_{0 , Km + k} = - K + 2 , \\ {\sum }_{k = 1}^{K} {\sum }_{l = 1}^{K} {y}_{Km + k , Km + l} = {( - K + 2 )}^{2} & ( Formula 22 )\end{matrix}$$

Thus, the optimization unit 37 can generate an SDP problem shown in the following Formula 23. This problem is equivalent to the problem shown in the foregoing Formula 16, and is a result of relaxing the foregoing Formula 10. Hence, an optimal value of Formula 23 is the upper bound of an optimal value of the foregoing Formula 10.

$$\begin{matrix}[ Math . 34 ] & \\ \begin{matrix}Maximize & A \cdot Y \\ subject to & Y = {( {y}_{ij} )}_{0 \leq i , j \leq KM} ∈ {Sym}_{KM + 1} , Y ≽ O . \\ & {Y}_{ii} = 1 ( i = 0 … KM ) . \\ & {\sum }_{k = 1}^{K} {y}_{0 , Km + k} = - K + 2 ( m = 0 … M - 1 ) . \\ & {\sum }_{k = 1}^{K} {\sum }_{l = 1}^{K} {y}_{Km + k , Km + l} = {( - K + 2 )}^{2} \\ & ( m = 0 … M - 1 )\end{matrix} & ( Formula 23 )\end{matrix}$$

A method of, when an optimal solution of the problem shown in Formula 23 is given, transforming the optimal solution to Z of the problem shown in Formula 10 is described below. This transformation operation is hereafter referred to as rounding. Let tilde Y be the optimal solution derived by SDP relaxation.

In the derivation of the foregoing Formula 16, “1” has been replaced with vector x₀, and tᵢ (i=1, . . . , KM) has been replaced with vector xᵢ. Accordingly, the relationship shown in the following Formula 24 exists between Z and Y.

[Math. 35]

2Zᵢ−1=tᵢ=1·tᵢ≈x^{T}₀xᵢ=y₀ᵢ (i=1 . . . KM) (Formula 24)

It can therefore be assumed that fixing Zᵢ to 1 for such i that tilde y₀ᵢ exceeds other tilde y₀ᵢ is appropriate. Based on this premise, the operation of the optimization unit 37 solving BQP shown in the foregoing Formula 10 by SDP relaxation is described below.

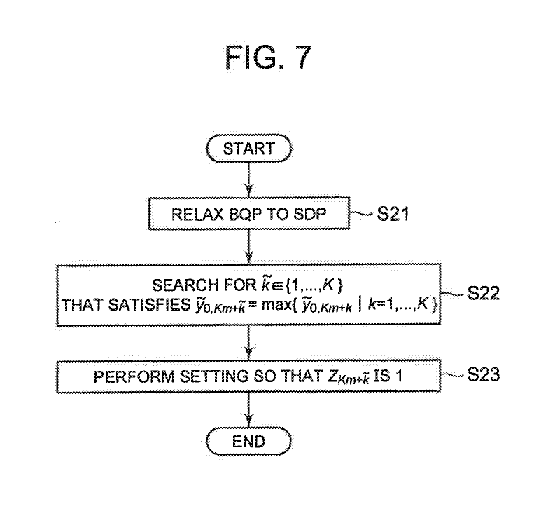

FIG. 7 is a flowchart depicting an example of the operation of the optimization unit 37 solving BQP by SDP relaxation. The operation example (algorithm) depicted in FIG. 7 performs rounding once.

The optimization unit 37 transforms the BQP shown in the foregoing Formula 10 to the problem shown in Formula 23 resulting from SDP relaxation (step S21), and sets the optimal solution as tilde Y. The optimization unit 37 searches for a value (hereafter denoted as tilde k) that satisfies the following Formula 25 (step S22), where tilde k is an element of {1, . . . , K}.

[Math. 36]

\tilde{y}_{0,Km+\tilde{k}}=max{\tilde{y}_{0,Km+k}|k=1 . . . K} (Formula 25)

The optimization unit 37 performs setting so that Z_{Km+tilde k} is 1 (the others are 0) (step S23).

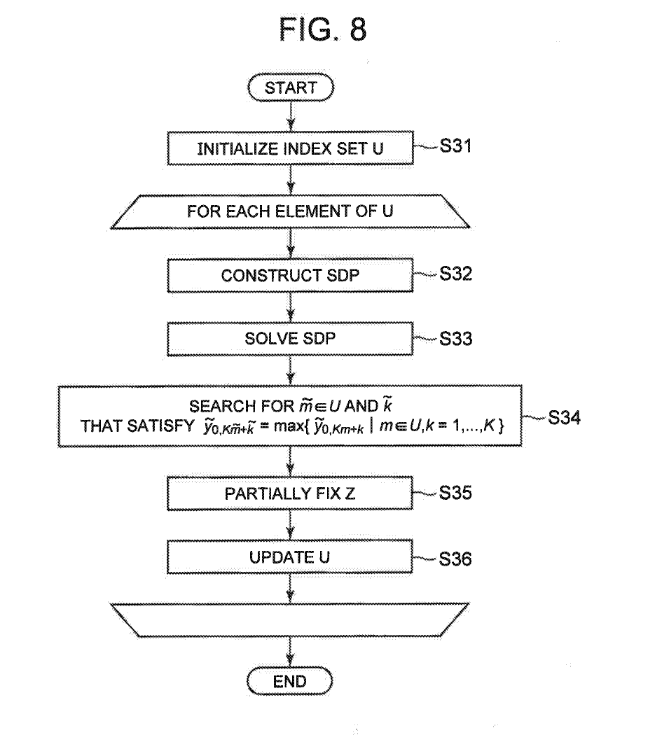

FIG. 8 is a flowchart depicting another example of the operation of the optimization unit 37 solving BQP by SDP relaxation. The operation example (algorithm) depicted in FIG. 8 performs rounding repeatedly.

The optimization unit 37 first initializes index set U={1, . . . , M} (step S31). The optimization unit 37 performs the following process for each index included in U (steps S32 to S36).

First, the optimization unit 37 partially fixes Z, and constructs the problem shown in the foregoing Formula 10 into the problem (i.e. SDP) shown in Formula 23 (step S32). The optimization unit 37 solves the problem shown in Formula 23, and sets the optimal solution as tilde Y (step S33). The optimization unit 37 searches for tildes m and k that satisfy the following Formula 26 (step S34). The optimization unit 37 then partially fixes Z based on the following Formula 27 (step S35).

$$\begin{matrix}[ Math . 34 ] & \\ \begin{matrix}Maximize & A \cdot Y \\ subject to & Y = {( {y}_{ij} )}_{0 \leq i , j \leq KM} ∈ {Sym}_{KM + 1} , Y ≽ O . \\ & {Y}_{ii} = 1 ( i = 0 … KM ) . \\ & {\sum }_{k = 1}^{K} {y}_{0 , Km + k} = - K + 2 ( m = 0 … M - 1 ) . \\ & {\sum }_{k = 1}^{K} {\sum }_{l = 1}^{K} {y}_{Km + k , Km + l} = {( - K + 2 )}^{2} \\ & ( m = 0 … M - 1 )\end{matrix} & ( Formula 23 )\end{matrix}$$

The optimization unit 37 updates U as follows (step S36).

[Math. 38]

U:=U\{\tilde{m}}

The optimization unit 37 acquires the following three values, by applying the algorithm depicted in FIG. 7 or 8 to the problem shown in the foregoing Formula 10. The first is computed (approximate) solution to the problem shown in Formula 10. The second is computed (approximate) optimal value of the problem shown in Formula 10. The third is an optimal value of the problem shown in Formula 23. This yields an inequality shown in the following Formula 28.

0<computed optimal value of Formula 10?optimal value of Formula 10?optimal value of Formula 23 (Formula 28)

Thus, the computed solution is guaranteed to satisfy the following Formula 29.

approximation rate of computed solution=(computed optimal value of Formula 10)/(optimal value of Formula 10)?(computed optimal value of Formula 10)/(optimal value of Formula 23) (Formula 29)

With this inequality, the quality of the calculated solution can be evaluated, and a more sophisticated algorithm such as branch and bound method can be derived.

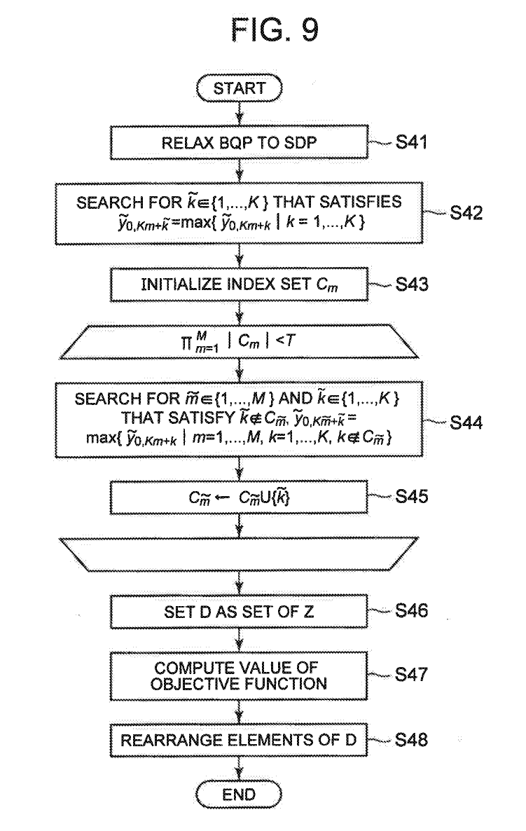

The optimization unit 37 may perform exhaustive search for a solution based on a parameter defined by the user. FIG. 9 is a flowchart depicting yet another example of the operation of the optimization unit 37 solving BQP by SDP relaxation.

The operation example (algorithm) depicted in FIG. 9 enumerates at least a solution of T near an optimal solution, where T is a parameter defined by the user.

The optimization unit 37 transforms the BQP shown in the foregoing Formula 10 to the problem shown in Formula 23 resulting from SDP relaxation (step S41), and sets the optimal solution as tilde Y. The optimization unit 37 searches for a value (tilde k) that satisfies the following Formula 30 (step S42). The optimization unit 37 also initializes index set Cₘ as shown in the following Formula 31 (step S43).

[Math. 39]

\tilde{y}_{0,Km+\tilde{k}}=max{\tilde{y}_{0,Km+k}|k=1 . . . K} (Formula 30)

Cₘ={\tilde{k}}⊆{1 . . . K} (Formula 31)

The optimization unit 37 repeatedly performs the following process while the following Formula 32 is satisfied (steps S44 to S45).

[Math. 40]

Π^{M}ₘ₌₁|Cₘ|<T (Formula 32)

The optimization unit 37 searches for two values (tildes m and k) that satisfy the following Formula 33 (step S44), where tilde m is an element of {1, . . . , M}, and tilde k is an element of {1, . . . , K}.

[Math. 41]

\tilde{k}∉C_{\tilde{m}}. \tilde{y}_{0,K\tilde{m}+\tilde{k}}=max{\tilde{y}_{0,Km+k}|m=1 . . . M, k=1 . . . K. k∉C_{\tilde{m}}} (Formula 33)

The optimization unit 37 further adds tilde k to set C_{tilde m} (step S45). In detail, this is represented by the following Formula 34.

[Math. 42]

C_{\tilde{m}}←C_{\tilde{m}}∪{\tilde{k}} (Formula 34)

The optimization unit 37 sets D as a set of Z (step S46), where Z is given in the following form. In this case, D satisfies the following Formula 35.

$$\begin{matrix}[ Math . 43 ] & \\ Z ∈ {\{ 0 , 1 \}}^{KM} Z = {[ {Z}_{1}^{T} … {Z}_{M}^{T} ]}^{T} \\ {Z}_{m} = {[ 0 … 0. {{1}^{⋁}}^{k} . 0 … 0 ]}^{T} ( k ∈ {C}_{m} ) & ( Formula 35 ) \\ \vert 𝒟 \vert = {\prod }_{m = 1}^{M} \vert {C}_{m} \vert \geq T & \end{matrix}$$

The optimization unit 37 computes the value of the objective function for all Z (step S47), and rearranges the elements of D with the computed values (step S48).

The algorithm depicted in FIG. 9 combines SDP relaxation and exhaustive search. By the optimization unit 37 performing optimization using the algorithm depicted in FIG. 9, it is possible to limit the range of exhaustive search using the solution of SDP.

Thus, this exemplary embodiment describes the optimization system that optimizes programming represented by a BQP problem. In detail, the optimization unit 37 relaxes a BQP problem to an SDP problem, and derives a solution of the SDP problem. Thus, an optimal solution can be derived at very high speed, as compared with a known typical BQP solving method.

As a result of an experiment using the method in this exemplary embodiment by means of a computer, a process requiring several hours to obtain an optimal solution of BPQ by a typical method was able to be accelerated to about 1 second.

Although this exemplary embodiment describes the operation of the optimization unit 37 using BQP formulated as shown in the foregoing Formula 10 as an example, BQP may be formulated as shown in the following Formula 36.

$$\begin{matrix}[ Math . 44 ] & \\ \begin{matrix}Maximize & {Z}^{T} QZ + {r}^{T} Z \\ subject to & Z = {[ {Z}_{1} … {Z}_{n} ]}^{T} ∈ {\{ 0 , 1 \}}^{n} , \\ & {\sum }_{i ∈ {I}_{s}} {Z}_{i} = 1 ( s = 1 … S ) , \\ & {a}_{n}^{T} t = 2 {b}_{u} - {1}^{T} {a}_{u} ( u = 1 … U ) , \\ & {c}_{υ}^{T} t \leq 2 {d}_{υ} - {1}^{T} {c}_{p} ( υ = 1 … V )\end{matrix} & ( Formula 36 )\end{matrix}$$

Let A be defined by the foregoing Formula 13. In this case, the problem shown in Formula 36 is equivalent to the problem shown in the following Formula 37. Relaxing the problem shown in Formula 37 yields the following Formula 38.

$$\begin{matrix}[ Math . 45 ] & \\ \begin{matrix}Maximize & [ 1 {t}^{T} ] A [ \begin{matrix}1 \\ t\end{matrix} ] \\ subject to & t = {[ {t}_{1} … {t}_{n} ]}^{T} ∈ {\{ - 1 , 1 \}}^{n} , \\ & {\sum }_{i ∈ {I}_{o}} {t}_{i} = 2 - \vert {I}_{s} \vert ( s = 1 … S ) , \\ & {a}_{n}^{T} t = 2 {b}_{u} - {1}^{T} {a}_{u} ( u = 1 … U ) , \\ & {c}_{υ}^{T} t \leq 2 {d}_{υ} - {1}^{T} {c}_{p} ( υ = 1 … V )\end{matrix} & ( Formula 37 ) \\ \begin{matrix}Maximize & A \cdot Y \\ subject to & Y = {( {y}_{ij} )}_{0 \leq i , j \leq n} ∈ {Sym}_{n + 1} , Y ≽ O , \\ & {y}_{i} = 1 ( i = 0 … n ) , \\ & {\sum }_{i ∈ {I}_{s}} {y}_{0 , i} = 2 - \vert {I}_{s} \vert ( s = 1 … S ) , \\ & {\sum }_{i ∈ {I}_{s}} {\sum }_{j ∈ {I}_{s}} {y}_{i , j} = {( 2 - \vert {I}_{s} \vert )}^{2} ( s = 1 … S ) , \\ & {\sum }_{i = 1}^{n} {a}_{u , i} {y}_{0 , i} = 2 {b}_{u} - {1}^{T} {a}_{u} ( u = 1 … U ) , \\ & {\sum }_{i = 1}^{n} {\sum }_{j = 1}^{n} {a}_{u , i} {a}_{u , j} {y}_{i , j} = {( 2 {b}_{u} - {1}^{T} {a}_{u} )}^{2} \\ & ( u = 1 … U ) , \\ & {\sum }_{i = 1}^{n} {c}_{v , i} y 0 , i \leq 2 {d}_{v} - {1}^{T} {c}_{u} ( υ = 1 … V )\end{matrix} & ( Formula 38 )\end{matrix}$$

The problem shown in Formula 38 can be rewritten in a standard form including equalities and inequalities as shown in the following Formula 39. Here, B₄ᵤ, B₅ᵤ, and B₆ᵤ are defined in the following Formula 40, and B₁ᵢ, B₂ₛ, and B₃ₛ which are elements of Symₙ₊₁ are defined in the following Formula 41.

$$\begin{matrix}[ Math . 46 ] & \\ \begin{matrix}Maximize & A \cdot Y \\ subject to & Y = {( {y}_{ij} )}_{0 \leq i , j \leq n} ∈ {Sym}_{n + 1} , Y ≽ O , \\ & {B}_{1 i} \cdot Y = 1 ( i = 0 … n ) , \\ & {B}_{2 s} \cdot Y = 2 - \vert {I}_{s} \vert ( s = 1 … S ) , \\ & {B}_{3 s} \cdot Y = {( 2 - \vert {I}_{s} \vert )}^{2} ( s = 1 … S ) , \\ & {B}_{4 u} \cdot Y = 2 {b}_{u} - {1}^{T} {a}_{u} ( u = 1 … , U ) , \\ & {B}_{5 u} \cdot Y = {( 2 {b}_{u} - {1}^{T} {a}_{u} )}^{2} ( u = 1 … U ) , \\ & {B}_{6 υ} \cdot Y \leq 2 {b}_{υ} - {1}^{T} {c}_{υ} ( υ = 1 … , V )\end{matrix} & ( Formula 39 ) \\ {B}_{4 u} = \frac{1}{2} [ \begin{matrix}0 & {a}_{u}^{T} \\ {a}_{u} & {O}_{n , n}\end{matrix} ] , {B}_{5 u} = [ \begin{matrix}0 & {0}_{n}^{T} \\ {0}_{n} & {a}_{u} {a}_{u}^{T}\end{matrix} ] , \\ {B}_{6 υ} = \frac{1}{2} [ \begin{matrix}0 & {c}_{υ}^{T} \\ {c}_{υ} & {O}_{n , n}\end{matrix} ] & ( Formula 40 ) \\ {B}_{1 s} [ k , j ] = \{ \begin{matrix}1 & ( k = j = i ) \\ 0 & otherwise\end{matrix} \\ {B}_{2 s} [ k , j ] = \{ \begin{matrix}1 \text{/} 2 & ( k = 0 , j ∈ {I}_{s} ) \\ 1 \text{/} 2 & ( j = 0 , k ∈ {I}_{s} ) \\ 0 & otherwise\end{matrix} \\ {B}_{3 s} [ k , j ] = \{ \begin{matrix}1 & ( k , j ∈ {I}_{s} ) \\ 0 & otherwise\end{matrix} & ( Formula 41 )\end{matrix}$$

Meanwhile, the problem shown in the foregoing Formula 39 can be rewritten in a standard form represented by equalities as shown in the following Formula 42. Here, A′, B′₁ᵢ, B′₂ₛ, B′₃ₛ, B′₄ᵤ, B′₅ᵤ, and B′₆ᵥ are defined in the following Formula 43, and Kᵥ which is an element of Symᵥ is given by the following Formula 44.

$$\begin{matrix} [ Math . 47 ] & \\ \begin{matrix}Maximize & {A}^{′} \cdot {Y}^{′} \\ subject to & {Y}^{′} = [ \begin{matrix}Y & & & \\ & {α}_{1} & & \\ & & ⋱ & \\ & & & {α}_{V}\end{matrix} ] ∈ {Sym}_{n + V + 1} . {Y}^{′} ≽ O , \\ & {B}_{1 i}^{′} \cdot {Y}^{′} = 1 ( i = 0 … n ) , \\ & {B}_{2 i}^{′} \cdot {Y}^{′} = 2 - \vert {I}_{s} \vert ( s = 1 … S ) , \\ & {B}_{3 s}^{′} \cdot {Y}^{′} = {( 2 - \vert {I}_{s} \vert )}^{2} ( s = 1 … , S ) , \\ & {B}_{4 u}^{′} \cdot {Y}^{′} = 2 {b}_{u} - {1}^{T} {a}_{u} ( u = 1 … U ) , \\ & {B}_{4 u}^{′} \cdot {Y}^{′} = {( 2 {b}_{u} - {1}^{T} {a}_{u} )}^{2} ( υ = 1 … U ) \\ & {B}_{6 υ}^{′} \cdot {Y}^{′} = 2 {d}_{u} - {1}^{T} {a}_{u} ( u = 1 … V )\end{matrix} & ( Formula 42 ) \\ {A}^{′} = [ \begin{matrix}A & {O}_{n + 1 , V} \\ {O}_{n - 1 , V} & {O}_{V , V}\end{matrix} ] \cdot {B}_{1 i}^{′} = [ \begin{matrix}{B}_{1 i} & {O}_{n + 1 , V} \\ {O}_{n - 1 , V} & {O}_{V , V}\end{matrix} ] \cdot {B}_{2 s}^{′} = [ \begin{matrix}{B}_{2 s} & {O}_{n + 1 , V} \\ {O}_{n - 1 , V} & {O}_{V , V}\end{matrix} ] \cdot {B}_{3 s}^{′} = [ \begin{matrix}{B}_{3 s} & {O}_{n + 1 , V} \\ {O}_{n - 1 , V} & {O}_{V , V}\end{matrix} ] \cdot {B}_{4 n}^{′} = [ \begin{matrix}{B}_{4 n} & {O}_{n + 1 , V} \\ {O}_{V , n + 1} & {O}_{V , V}\end{matrix} ] \cdot {B}_{5 n}^{′} = [ \begin{matrix}{B}_{5 n} & {O}_{n + 1 , V} \\ {O}_{V , n + 1} & {O}_{V , V}\end{matrix} ] \cdot {B}_{6 n}^{′} = [ \begin{matrix}{B}_{6 n} & {O}_{n + 1 , V} \\ {O}_{V , n + 1} & {O}_{V , V}\end{matrix} ] & ( Formula 43 ) \\ {K}_{υ} [ i , j ] = \{ \begin{matrix}1 & ( i = j = r ) \\ 0 & otherwise\end{matrix} & ( Formula 44 )\end{matrix}$$

A dual problem of the problem shown in the foregoing Formula 36 is described below. The dual problem of the problem shown in Formula 36 is defined in the following Formula 45.

$$\begin{matrix} [ Math . 48 ] & \\ \begin{matrix}Minimize & {r}_{1}^{T} {x}_{1} + {r}_{2}^{T} {x}_{2} + {r}_{3}^{T} {x}_{3} + {r}_{4}^{T} {x}_{4} + {r}_{5}^{T} {x}_{5} + {r}_{6}^{T} {x}_{6} \\ subject to & {x}_{1} ∈ {ℝ}^{n + 1} , {x}_{2} , {x}_{3} ∈ {ℝ}^{S} , {x}_{4} , {x}_{5} ∈ {ℝ}^{U} , {x}_{6} ∈ {ℝ}^{V} , \\ & {\sum }_{i = 0}^{n} {x}_{1 i} {B}_{1 i}^{′} + {\sum }_{s = 1}^{S} {x}_{2 s} {B}_{2 s}^{′} + {\sum }_{s = 1}^{S} {x}_{3 s} {B}_{3 s}^{′} + \\ & {\sum }_{s = 1}^{S} {x}_{4 n} {B}_{4 n}^{′} + {\sum }_{u = 1}^{U} {x}_{4 u} {B}_{4 u}^{′} + {\sum }_{v = 1}^{V} {x}_{6 v} {B}_{6 v}^{′} - A \geq O\end{matrix} & ( Formula 45 )\end{matrix}$$

In Formula 45, fⱼ is given in the right side of the constraint of the foregoing Formula 42, and xⱼ is a variable.

When feasible solution Z is given in Formula 36, the feasible solution in Formula 42 can be represented by the following Formula 46.

$$\begin{matrix}[ Math . 49 ] & \\ {Y}^{′} = [ \begin{matrix}1 & {Z}^{T} & & & \\ Z & {ZZ}^{T} & & & \\ & & 2 ( {d}_{1} - {c}_{1}^{T} Z ) & & \\ & & & ⋱ & \\ & & & & 2 ( {d}_{1} - {c}_{1}^{T} Z )\end{matrix} ] & ( Formula 46 )\end{matrix}$$

The feasible solution of the dual problem shown in Formula 45 is given by the following Formula 47.

$$\begin{matrix}[ Math . 50 ] & \\ {x}_{1 i} = {\sum }_{j = 0}^{n} \vert A [ i , j ] \vert , \\ {x}_{m} = 0 ( m = 2 , … 6 ) & ( Formula 47 )\end{matrix}$$

Thus, the optimization unit 37 can use the foregoing Formulas 46 and 47 as an initial solution of the problem shown in the foregoing Formula 42.

This is summarized as follows. The optimization unit 37 relaxes a BQP problem shown in the following Formula 48 to an SDP problem shown in the following Formula 49. In detail, the optimization unit 37 relaxes a BQP problem with 1-of-K constraint (one-hot constraint), linear equality constraint, and linear inequality constraint as shown in Formula 48, to an SDP problem. The optimization unit 37 then transforms a solution derived from the problem shown in Formula 49 to a solution of the problem shown in Formula 48, thus deriving an optimal solution of the problem shown in Formula 48.

$$\begin{matrix}[ Math . 51 ] & \\ \begin{matrix}Input \text{:} & Q ∈ {ℝ}^{n \times n} , r ∈ {ℝ}^{n} , {\{ {I}_{s} \}}_{s = 1}^{S} , \\ & {\{ ( {a}_{u} \cdot {b}_{u} ) \}}_{u = 1}^{U} \cdot {\{ ( {c}_{υ} \cdot {d}_{υ} ) \}}_{υ = 1}^{V} , \\ Maximize & {Z}^{T} QZ + {r}^{T} Z \\ subject to & Z = {[ {Z}_{1} … , {Z}_{n} ]}^{T} ∈ {\{ 0 , 1 \}}^{n} , \\ & {\sum }_{i ∈ {I}_{n}}^{ } {Z}_{i} = 1 ( s = 1 … S ) , \\ & {a}_{u}^{T} Z = {b}_{u} ( u = 1 … U ) , \\ & {c}_{υ}^{T} Z = {d}_{υ} ( υ = 1 … V )\end{matrix} & ( Formula 48 ) \\ \begin{matrix}Input \text{:} & A ∈ {ℝ}^{( n + 1 ) \times ( n + 1 )} \cdot {\{ {I}_{s} \}}_{s = 1}^{S} \cdot \\ & {\{ ( {a}_{u} \cdot {b}_{u} ) \}}_{u = 1}^{U} \cdot {\{ ( {c}_{υ} \cdot {d}_{υ} ) \}}_{υ = 1}^{V} , \\ Maximize & A \cdot Y \\ subject to & Y = {( {y}_{ij} )}_{0 \leq i , j \leq KM} ∈ {Sym}_{n + 1} , Y ≽ O . \\ & {Y}_{ii} = 1 ( i = 0 … n ) . \\ & \begin{matrix}{\sum }_{i ∈ {I}_{s}} {y}_{0 , i} = 2 - \vert {I}_{s} \vert ( s = 1 … S ) , \\ {\sum }_{i ∈ {I}_{s}} {\sum }_{j ∈ {I}_{s}} {y}_{i , j} = {( 2 - \vert {I}_{s} \vert )}^{2} ( s = 1 … S ) , \\ {\sum }_{i = 1}^{n} {a}_{u , i} {y}_{0 , i} = 2 {b}_{u} - {1}^{T} {a}_{u} ( u = 1 … U ) , \\ {\sum }_{i = 1}^{n} {\sum }_{j = 1}^{n} {a}_{u , i} {a}_{u , j} {y}_{i , j} = {( 2 {b}_{u} - {1}^{T} {a}_{u} )}^{2} \\ ( u = 1 … U ) , \\ {\sum }_{i = 1}^{n} {c}_{v , i} y 0 , i \leq 2 {d}_{v} - {1}^{T} {c}_{u} ( υ = 1 … V )\end{matrix}\end{matrix} & ( Formula 49 )\end{matrix}$$

In Formula 48, S is the number of 1-of-K constraints (one-hot constraints), U is the number of linear equality constraints, and V is the number of linear inequality constraints. Of the input in Formula 48, a and c are n-dimensional vectors, and b and d are scalar values. In Formula 49, vector aᵤ=(a_{u,1}, a_{u,2}, . . . , a_{u,n})^{T}, and vector cᵤ=(c_{u,1}, c_{u,2}, . . . , c_{u,n})^{T}. Here, superscript T indicates transposition.

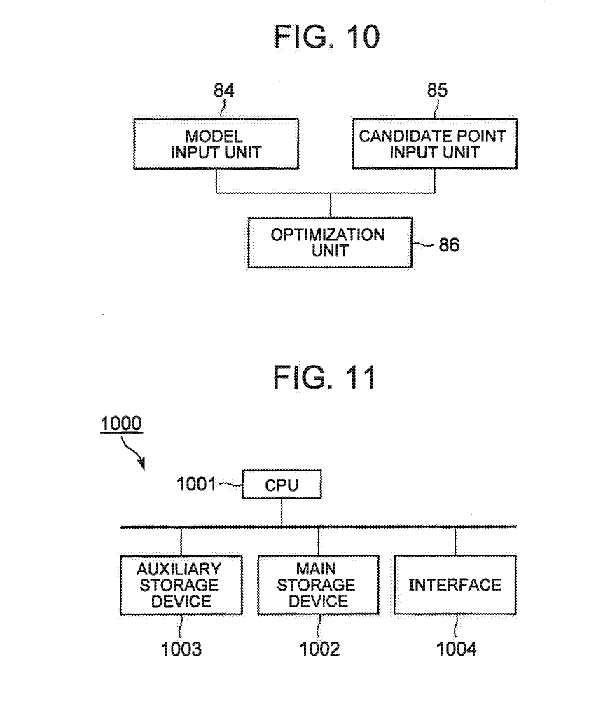

The present invention is summarized below. FIG. 10 is a block diagram schematically depicting an optimization system according to the present invention. The optimization system according to the present invention is an optimization system for optimizing a value of an objective variable so that a value of an objective function is optimal, and includes: a model input unit 84 (e.g. the predictive model input unit 31) for receiving a linear regression model represented by a function having the objective variable as an explanatory variable; a candidate point input unit 85 (e.g. the candidate point input unit 36) for receiving, for the objective variable included in the linear regression model, at least one candidate point which is a discrete candidate for a possible value of the objective variable; and an optimization unit 86 (e.g. the optimization unit 37) for calculating the objective variable that optimizes the objective function having the linear regression model as an argument. The optimization unit 86 selects a candidate point that optimizes the objective variable, to calculate the objective variable.

With such a structure, mathematical optimization can be solved at high speed with high accuracy even in the case where a predictive model used for optimization is based on a non-linear basis function.

In detail, the linear regression model is represented by a function based on non-linear transformation of the objective variable, and the optimization unit 86 discretizes the objective variable for which the candidate point is received to result in a binary quadratic programming problem, to optimize the objective function.

As an example, the linear regression model is a model that includes a demand of a service or product as an explained variable and a price of the service or product as the explanatory variable. The objective function is a function indicating a total sales revenue for a plurality of services or products. The objective variable indicates a price of each of the plurality of services or products.

As another example, the linear regression model is a model that includes a sales revenue of a service or product as an explained variable and a price of the service or product as the explanatory variable. The objective function is a function indicating a total sales revenue for a plurality of services or products. The objective variable indicates a price of each of the plurality of services or products.

Moreover, the candidate point input unit 85 may display a list of objective variables subjected to optimization and one or more candidates for a possible value of each objective variable, and receive a candidate selected by a user as the candidate point.

The optimization system may include a predictive model generation unit (e.g. the learner 20) for generating a predictive model by machine learning, based on objective variable historical data acquired in the past. The model input unit 84 may receive the generated predictive model. With such a structure, a large number of objective variables or more complex objective functions can be automatically generated from past data.

An example of optimizing product price is given below. With a typical optimization method, in the case of simultaneously optimizing the prices of a large volume of products (e.g. 1000 products), it is difficult to manually optimize the price of each product. Besides, the optimization requires manually performing very simple prediction.

In this exemplary embodiment, on the other hand, the predictive model generation unit can automatically generate various models from data by machine learning, so that the generation of a large number of predictive models, the generation of complex objective variables, etc. can be automatized. By automatizing such processes, for example when the tendency of data changes, a machine learning model can be automatically updated to automatically perform optimization again (operation automatization).

The present invention realizes a process of solving a mathematical programming problem and a process of generating a predictive model, by the capability of a processor (computer) of processing massive data at high speed in a short time. Accordingly, the present invention is not limited to simple mathematical processing, but fully uses a computer to acquire a prediction result and an optimization result from massive data at high speed through the use of a mathematical programming problem.

FIG. 11 is a schematic block diagram depicting the structure of a computer according to at least one exemplary embodiment. A computer 1000 includes a CPU 1001, a main storage device 1002, an auxiliary storage device 1003, and an interface 1004.

The learner 20 and the optimization device 30 are each implemented by the computer 1000. The computer 1000 implementing the learner 20 may be different from the computer 1000 implementing the optimization device 30. The operation of each processing unit described above is stored in the auxiliary storage device 1003 in the form of a program (information processing program or optimization program). The CPU 1001 reads the program from the auxiliary storage device 1003, expands the program in the main storage device 1002, and executes the above-mentioned process according to the program. The learner 20 and the optimization device 30 may each be realized by electric circuitry. The term “circuitry” here conceptually covers single device, multiple devices, chipset, and cloud.

In at least one exemplary embodiment, the auxiliary storage device 1003 is an example of a non-transitory tangible medium. Examples of the non-transitory tangible medium include a magnetic disk, magneto-optical disk, CD-ROM, DVD-ROM, and semiconductor memory connected via the interface 1004. In the case where the program is distributed to the computer 1000 through a communication line, the computer 1000 to which the program has been distributed may expand the program in the main storage device 1002 and execute the above-mentioned process.

The program may realize part of the above-mentioned functions. The program may be a differential tile (differential program) that realizes the above-mentioned functions in combination with another program already stored in the auxiliary storage device 1003.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

This application claims priority based on U.S. Provisional Application No. 62/235,044 tiled on Sep. 30, 2015, the disclosure of which is incorporated herein in its entirety.

### REFERENCE SIGNS LIST

10 training data storage unit

20 learner

30 optimization device

31 predictive model input unit

32 external information input unit

33 storage unit

34 problem storage unit

35 constraint condition input unit

36 candidate point input unit

37 optimization unit

38 output unit

39 objective function aeneration unit

1. An optimization system for optimizing a value of an objective variable so that a value of an objective function is optimal, the optimization system comprising:
a hardware including a processor;
a model input unit, implemented by the processor, for receiving a linear regression model represented by a function having the objective variable as an explanatory variable;
a candidate point input unit, implemented by the processor, for receiving, for the objective variable included in the linear regression model, at least one candidate point which is a discrete candidate for a possible value of the objective variable; and
an optimization unit, implemented by the processor, for calculating the objective variable that optimizes the objective function having the linear regression model as an argument,
wherein the optimization unit selects a candidate point that optimizes the objective variable, to calculate the objective variable.

2. The optimization system according to claim 1, wherein the linear regression model is represented by a function based on non-linear transformation of the objective variable, and
wherein the optimization unit discretizes the objective variable for which the candidate point is received to result in a binary quadratic programming problem, to optimize the objective function.

3. The optimization system according to claim 1, wherein the linear regression model is a model that includes a demand of a service or product as an explained variable and a price of the service or product as the explanatory variable,
wherein the objective function is a function indicating a total sales revenue for a plurality of services or products, and
wherein the objective variable indicates a price of each of the plurality of services or products.

4. The optimization system according to claim 1, wherein the linear regression model is a model that includes a sales revenue of a service or product as an explained variable and a price of the service or product as the explanatory variable,
wherein the objective function is a function indicating a total sales revenue for a plurality of services or products, and
wherein the objective variable indicates a price of each of the plurality of services or products.

5. The optimization system according to claim 1, wherein the candidate point input unit displays a list of objective variables subjected to optimization and one or more candidates for a possible value of each objective variable, and receives a candidate selected by a user as the candidate point.

6. An optimization method for optimizing a value of an objective variable so that a value of an objective function is optimal, the optimization method comprising:
receiving a linear regression model represented by a function having the objective variable as an explanatory variable;
receiving, for the objective variable included in the linear regression model, at least one candidate point which is a discrete candidate for a possible value of the objective variable; and
calculating the objective variable that optimizes the objective function having the linear regression model as an argument,
wherein in the optimization, a candidate point that optimizes the objective variable is selected to calculate the objective variable.

7. The optimization method according to claim 6, wherein the linear regression model is represented by a function based on non-linear transformation of the objective variable, and
wherein the objective variable for which the candidate point is received is discretized to result in a binary quadratic programming problem, to optimize the objective function.

8. A non-transitory computer readable information recording medium storing an optimization program applied to a computer for optimizing a value of an objective variable so that a value of an objective function is optimal, the optimization program, when executed by a processor, performs a method for:
receiving a linear regression model represented by a function having the objective variable as an explanatory variable;
receiving, for the objective variable included in the linear regression model, at least one candidate point which is a discrete candidate for a possible value of the objective variable; and
calculating the objective variable that optimizes the objective function having the linear regression model as an argument,
wherein in the optimization candidate point that optimizes the objective variable is selected to calculate the objective variable.

9. The non-transitory computer readable information recording medium according to claim 8, wherein the linear regression model is represented by a function based on non-linear transformation of the objective variable, and
wherein the objective variable for which the candidate point is received is discretized to result in a binary quadratic programming problem, to optimize the objective function.
